(19) United States
(12) Patent Application Publication
(10) Pub. No.: US 2019/0102135 A1
(43) Pub. Date: Apr. 4, 2019

(54) SCALABLE INTERACTION WITH MULTI-DISPLAYS

(71) Applicant: Summit Technology Laboratory, Irvine, CA (US)

(72) Inventors: Duy-Quoc Lai, Santa Ana, CA (US); Mehdi Rahimzadeh, Irvine, CA (US)

(21) Appl. No.: 16/151,060

(22) Filed: Oct. 3, 2018

Related U.S. Application Data
(60) Provisional application No. 62/567,668, filed on Oct. 3, 2017.

(51) Int. Cl. G06F 3/14; G06F 3/041; G06F 3/033; G09G 5/14; G06K 7/14; G06K 19/06

(52) U.S. Cl. CPC G06F 3/1446; G06F 3/041; G06F 3/033; G09G 5/14; G06F 3/017; G06K 19/06028; G09G 2354/00; G09G 2370/02; G06K 7/1413

(57) ABSTRACT

Systems and methods for multiple users to interact with a multi-display using multiple modalities. The multi-display allows a lucid transition between personal non-private work environment and shared work environment for multiple groups of users in an open workspace. This provides users with freedom to use large amounts of space (with or without whiteboard) and the aggregate compute and storage resources available in an open workspace in any configuration suitable for their work dynamics and applications. It allows users to explore and manipulate data using a branch explore merge paradigm via a combination of personal display spaces to create shared display spaces and segregation of personal displays thereof on-demand using interaction modalities like hand gestures, laser pointers and even personal devices. The result is a paradigm where the displays are used as mediums for interacting with the data.

### CROSS REFERENCE

This application is a non-provisional and claims benefit of U.S. patent application Ser. No. 62/567,668, filed Oct. 3, 2017, the specification(s) of which is/are incorporated herein in their entirety by reference.

### FIELD OF THE INVENTION

The present invention relates to sharing and interacting with data and software on a multi-display that facilitates one or more users to interact with the one or more displays. For example, different devices (e.g. laser pointers, personal devices like mobile phone or a tablet, desktops or even hand gestures) can interact with single or multi-displays.

### BACKGROUND OF THE INVENTION

Today's trend is to get rid of personal offices and create large expansive work areas with open desk spaces for multiple individuals. The goal of such an environment is to foster a higher degree of collaboration and dialogue that is not possible in an environment of closed door personal offices. Although tools to interact with personal data have exploded in the past few years, there are hardly any collaborative tools that can match the scale and modality of interactions that today's work spaces require. It is an objective of the present invention to integrate personal, yet non-private, workspaces with the shared workspace such that office environments of today can easily accommodate the collaborative experience they are designed for.

The present invention features a nomadic displays paradigm that is designed specifically for the evolving multi-user workspaces. Nomadic displays allow a lucid transition between personal non-private work environments and shared work environments empowered by an interface of porting multiple desktops on a multi-display. It also allows multiple groups of users the freedom to use the huge amount of wall space (with or without whiteboard) and the aggregate compute and storage resources available to them in any configuration suitable for their work dynamics and applications. They can use single or multiple displays of different size, resolution and form factors on demand at the location that the users desire—in other words, displays of desired configuration come to the users rather than users moving to them. Multiple users can combine their personal workspaces to create a larger shared workspace during collaboration. Following completion of collaborative exchanges, users can just segregate the displays to go back to their personal display spaces. The nomadic displays enable the paradigm of branch, explore (via interaction), and merge for collaborative work that has been shown to be a conducive form of exploration for less complex small data using different windows on singe desktop machines, but has not been explored before in the context of multiple machines and multiple displays for massive data manipulation.

Prior works have used the branch-explore-merge paradigm when collaborating with simple and small 2D data in which they use the proximity of personal devices as a cue to merge them into a shared display or branch out from a merged display to a personal display. However, the nomadic displays provide a general and scalable way to extend such concepts to large systems of n displays and m machines available in today's open workspaces. Collaborative manipulation of massive 3D data is still complicated despite a tremendously large body of prior works that exist for shared interaction among multiple users. The following section categorizes the prior works in different classes and discusses their capabilities and shortcomings in the context of nomadic displays.

Single Communal Display (SCD)—A large communal display that offers the scale required for multi-user interactions has been explored using a single display device and has been shown to be effective for multi-user collaboration when using 2D image based applications. Tiled multi-displays have also been used for the same purpose and several registration methods have been proposed to build such scalable displays using multiple overlapping projectors. A large number of user interfaces have been suggested for interacting with such displays, mostly for 2D applications. These interfaces can use distal modalities like laser pointers, remote control or proximal modalities like hand gestures, pen, and even handheld projectors using a flashlight metaphor or a hybrid thereof. Several multi-user applications that can use such communal displays effectively have also been designed, but the most common of these has been about connecting multiple personal devices with single display based shared workspace primarily for 2D applications like transferring documents and pictures. However, all of these interactions have been tied together under a centralized server using one or more sensors to sense the entire display space and managing them in a unified coordinate system.

Single Immersive Display (SID)—Different distributed rendering paradigms can effectively visualize and navigate through large 3D data on a single multi-display wall or a single immersive display. This allows a single head-tracked user to trigger a change in the viewpoint of the rendered model during navigation through the 3D scene, but does not allow any manipulation of the 3D data. Several registration methods have addressed the problem of registering multiple projectors on non-planar surfaces to build such single user immersive 3D environments.

Multi-Display Environments (MDE)—MDE consists of multiple fixed and planar displays on different locations (e.g. tables and walls), primarily in an office environment. Several interaction paradigms have been proposed to allow a single head-tracked user to interact with all these displays in a perspectively correct view or to bring the content of all the different displays onto one tabletop display and interact with them. It has also been explored in the context of a multi-user application in a software development environment where each of the displays in the multi-display user environment is being used by a single developer.

Spatially Augmented Reality (SAR) Environments—SAR has been a dream of the virtual reality/augmented reality (VR/AR) community where large, room-like environments have been instrumented with multiple projectors and RGB and/or depth cameras (e.g. Microsoft Kinect) to allow augmentation of the existing 3D objects with virtual imagery. A single head tracked user can collaborate with the environment around himself or get connected with a remote user in his environment via a window in the local environment or any other augmented object. Almost all of these works assume static positions of the devices and cannot move them around as demanded by the user. Similar static multi-device setups have been explored in the realm of theater set design. Some works have addressed the problem of registering such devices on environments that have moving objects or can change shape by designing applications that can change the appearance (via modification of color and texture) of an object in such an environment, but applications that manipulate massive 3D geometry has not been attempted before.

Dynamic Display (DD)—The concept of dynamic projection has only been explored in the context of a single projector-camera system. This unit augments static, mostly planar, 2D objects/environments with interactive interfaces, providing a novel interaction modality. A motorized mirror has been used to move the display output of a single projector around to light moving objects, focusing on tracking moving objects in the real world and orient the mirror such that the object is always illuminated by the projector. Registering single moving projector on 3D surfaces has been explored as well, but such dynamic projections have not been explored for multiple devices and in the context of multiple groups of collaborative users.

Nomadic Displays (ND)—Nomadic displays present a novel paradigm that is specifically catered towards multi-user collaborative manipulation of massive 3D geometry, which has not been attempted before. There currently exists no high resolution display system that can help multiple users to collaborate to design, model, and annotate massive 3D data while exploring them. Almost all applications focus on 2D data and most follow a tightly coupled architecture where a personal or shared display is coupled tightly to machine(s) and the data movement from the display implies a data movement from the associated machine(s). Further, dynamic projections have never been addressed in multi-device systems as in SAR environments. Dynamic personal devices have only been explored in the context of a single communal display for 2D data applications where a single camera monitors all devices centrally. Only SID and SAR environments can handle massive 3D data, but do not allow any manipulation.

Other early works explore laser pointer based interaction on a single projector-camera system using a custom interface on the screen. Commercial display surface input technologies like Microtouch, Smarttech, PixelSense, and SMART whiteboard use touchscreens for interaction for single users with limited and fixed size resolution. In a system that projects sheet of laser light just above the display surface, when an object penetrates the light, it is detected by a CCD thereby detecting an interaction. However, none of the above systems address multiple desktops or users. Further, physically touching the screen may be difficult or impossible for very large displays.

In contrast to the aforementioned works, the present invention provides a system of nomadic displays that has a dynamic distributed loosely coupled architecture leading to a very flexible and reconfigurable working environment where multiple groups can work on massive 3D data exploration and manipulation collaboratively. The adoption of nomadic displays is empowered by the interface of portable desktops that allows easy migration of personal desktops of multiple users on the multi-display.

The portable desktop interface is related to the recent single projector commercial technologies (e.g. Mimio and Epson Brightlink) that convert a wall or screen into an interactive display. A single short throw projector illuminates the wall. Two or four peripheral cameras capture the location of a stylus touching the illuminated region of the wall for detecting interactions. These are then routed as a mouse based interaction through only the MS Windows operating system on a single desktop. However, a stylus-based approach still needs touching the screen and is not general for rear projection systems. Most importantly, the invention provides a scalable solution comprising of multiple projectors for multiple desktops. The portable desktop interface is especially empowering for 3D massive data modeling and manipulation applications.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY OF THE INVENTION

In the present invention, the nomadic displays paradigm is achieved by conglomeration of the display space of one or more display devices. In one embodiment, each display device may comprise a projector and a camera. In another embodiment, the display device may be optionally mounted on a pan-tilt-unit (PTU). In some embodiments, the display devices may be steerable or non-steerable. Without wishing to limit the present invention, the branch-explore-merge paradigm can be implemented by actual merging and branching of the display space of the nomadic displays controlled using multiple interaction modalities from the user (e.g. mouse, keyboard, laser pointers, hand gestures) via an interface of multiple portable interactive desktops. This allows users to collaborate more comfortably while minimizing transition between the personal and the shared work environment.

In terms of underlying architectural design, unlike any previous works, the present invention segregates the display space made of n displays from the backbone of clusters of m machines in which the 3D data resides. This allows for connecting the n displays to the m machines in a network configuration which can be reconfigured from time to time based on the data flow and data requirement of multiple user groups in the workspace. This architecture provides users, the freedom to use a huge amount of wall space commensurate with the size of massive 3D data or multiple large desktops, and yet, not only the display, but the data source is also connected to the user's preferred location. The nomadic displays paradigm is enabled by the following critical components:
1. Building a complex computing backbone with a cluster of computers since a single computer cannot provide interactive rendering for such massive 3D data. The coupling between the machines and the displays are extremely loose and can be easily reconfigured.
2. Building an interface of portable desktops that allows users to connect and collaborate with other users on any multi-display without moving away from the comfort of using their own desktops.
3. Building a rich set of tools for interaction with the nomadic displays that can accommodate the work flow complexity of multiple groups of users who have the freedom to pool the steerable displays in many different ways.
4. Building a rich set of tools for real-time interaction with the 3D data or interaction with portable desktops enabled by the nomadic displays, especially for multiple users to modify and explore them simultaneously.

In some aspects, the present invention features a user interactive display system comprising a display surface shared by a plurality of display devices, one or more interaction devices, one or more sensors, and a communications network capable of capable of sending communications between the plurality of display devices, the one or more sensors, and a network of computing devices. Each display device may be operatively connected to a computing device in the network of computing devices. The display devices may be configured to display an image on the display surface. Each display device has a display field comprising a shape and position of a portion of the display surface that the display device is configured to display upon. Each display device may be configured to display a portion of the image in their display field. Each sensor may be operatively connected to a computing device in the network of computing devices, capable of observing an interaction of the one or more interaction devices. Each sensor has a field of view, in which the interaction must be within the field of view of the sensor to be observed. The fields of view of the one or more sensors may be jointly disposed to observe the display surface.

In some embodiments, one or more of the computing devices may be configured to execute corresponding instructions. The corresponding instructions are computer-readable instructions that may comprise detecting a plurality of display devices connected to one or more of the computing devices. For each display device connected to one or more of the computing devices, the method further comprises detecting the neighboring display devices of the display device, communicating with other computing devices to determine which computing devices are connected to the neighboring display devices, wherein the computing devices of the neighboring display units comprise the neighboring computing devices, determining the display field the display device controls, determining the portion of the image the display device displays based on the display field that the display device controls, registering the portion of the image to the display surface, displaying the image, and communicating with neighboring computing devices to match the features of the portion of the image to the portions of the image displayed by the neighboring display devices. In other embodiments, the method may further include detecting one or more sensors connected to the computing device, determining the portion of the display surface observed by each sensor connected to the computing device, receiving sensor data from the one or more sensors connected to the computing device, processing the sensor data to detect an interaction of the interaction device, communicating interactions to other computing devices, receiving interactions from other computing devices, sending data to other computing devices, receiving data from other computing devices, determining a reaction to a user interaction, and executing the reaction to the user interaction.

In some embodiments, the plurality of display devices together projects a display image on the display surface. A user controlling one of the interaction devices may execute an interaction with the display surface, which may be detected by one or more of the sensors. One or more of the computing devices process the sensor data to determine a user intent from the interaction, and execute a reaction to the user intent.

In other aspects, the present invention features a distributed method for controlling an interactive multi-display display system. The method may be executed by two or more computing devices of a multi-display system. The computing devices may comprise a computing cluster that share a memory storage and processing time collaboratively. In one embodiment, the method may comprise detecting a plurality of display devices connected to the two or more computing devices. For each display device connected to one of the computing devices, the method further comprises detecting the neighboring display devices of each display device, communicating with other computing devices to determine which computing devices are connected to the neighboring display devices, wherein the computing devices of the neighboring display units comprise the neighboring computing devices, determining a display field of the display device, wherein the display field is the shape and position of a portion of the display surface that the display device displays upon, determining the portion of the image to be displayed by the display device based on the display field of the display device, displaying the image from the display devices, and storing one or more information about the neighboring display devices, neighboring computing devices, display surface, image portion, image registration and image matching features in one or more configuration files.

In further embodiments, the method includes establishing a communications link with an interaction device, detecting one or more sensors connected to the computing device, determining the portion of the display surface observed by each sensor connected to the computing device, receiving sensor data from one or more sensors connected to the computing device, processing the sensor data to detect an interaction of the interaction device, communicating interactions between the neighboring computing devices, determining a reaction to a user interaction, and executing the reaction to the user interaction. In one embodiment, the step of communicating interactions between the neighboring computing devices may comprise receiving interactions from the neighboring computing devices, sending data to the neighboring computing devices, and receiving data from the neighboring computing devices. In another embodiment, the step of determining the reaction to the user interaction may comprise determining a user intent.

In some embodiments, the method may further comprise, for each display device connected to one of the computing devices, registering the portion of the image to the display surface, and communicating with neighboring computing devices to match the features of the portion of the image to the portions of the image displayed by the neighboring display devices. In other embodiments, the method may further comprise, for each display device connected to one of the computing devices, determining a region of overlap between the display fields of the neighboring display devices, and aligning the image features of the image portion to match the neighboring image portions in the overlap region. In yet other embodiments, the method may further comprise for each display device connected to one of the computing devices, displaying a bar code onto the display field of the display device, processing the sensor data to detect bar codes displayed by neighboring display devices, and determining the neighboring display devices based on their bar codes.

In some embodiments, the interface of portable desktops on multi-displays allows one or more users to plug in their laptops to the multi-display allowing the contents of their desktops to be projected on the entire display or part thereof, interact with such one or more desktops migrated on a multi-display via laser pointers, wireless keyboards or soft keyboards as an alternative to the mouse and the tethered keyboard. Finally, this interface is also backward compatible to single displays that can reduce inhibition pressures for early adoption.

According to some aspects, the present invention allows interaction by one or more users with a multi-display (e.g. LCD panels, rear or front projectors). The invention may comprise one or more interaction devices (e.g. clicker, laser pointer, smart phone, tablet, keyboard, mouse, body, hand, wireless wearable sensors including smart watches, tactile gloves etc), one or more interaction mechanisms (e.g. touching the mobile display, pointing the laser pointer at the display, placing tablet on the display, through keyboard and mouse, gestures, detecting state changes in wearable sensors), one or more interaction detection mechanisms (e.g. detecting touch on the mobile device, detecting laser lit points via one or more cameras, detecting hand or body gestures via one or more cameras and/or depth sensors, responses of wearable sensors), communication channels between the interaction detection mechanism and the display (e.g. wireless, Bluetooth, wired), and a reaction to interaction generated on the display. In some embodiments, the interaction device may or may not be augmented with codes or markers (e.g. QR® codes, color codes) to enable fast detection. QR® codes may include transforming the displayed image as demanded by the interaction and/or the application.

### BRIEF DESCRIPTION OF THE DRAWINGS

This patent application contains at least one drawing executed in color. Copies of this patent or patent application publication with color drawing(s) will be provided by the Office upon request and payment of the necessary fee.

The features and advantages of the present invention will become apparent from a consideration of the following detailed description presented in connection with the accompanying drawings in which:

FIG. 1A shows an embodiment of a user interactive display system of the present invention.

FIG. 1B is a non-limiting flow diagram of a method of the present invention.

FIG. 2 shows an exemplary schematic of the state of the art implementing a centralized server combining inputs and breaking down responses for multiple sensors and displays.

FIG. 3A shows a non-limiting schematic of the present invention.

FIG. 3B shows an alternative schematic of the present invention with tablet based interaction wherein sensors on mobile sense the user input.

FIGS. 4A-4M show a non-limiting example of communicating between personal devices held by multiple users and an interactive wall.

FIG. 5 shows an example of multiple users interacting with a display projected onto a curved surface using laser pointers.

FIG. 6 is a non-limiting example of a finite state machine flowchart for laser pointer gesture management. “Drop”, “Single Click”, and “Double Click” boxes are final states whereas the other boxes are middle states. Once a gesture is registered, the machine returns to states 0.

FIG. 7 shows a non-limiting embodiment of the nomadic displays paradigm using four active display nodes (ADNs). Two users have created their own personal workspace on the wall using conglomerate displays (CDs) of two active display nodes (ADNs) each (2×1 array). One is using a laser pointer to interact with his workspace while the other uses hand gestures.

FIG. 8 shows a non-limiting embodiment of a shared workspace with an airplane model and two personal workspaces with parts of the model checked out, all within the same CD made of four ADNs.

FIG. 9 shows another non-limiting embodiment of the nomadic displays paradigm made of four ceiling mounted ADNs creating two CDs each with two ADNs.

FIG. 10 is a projection of the ADN indicated by the AD boundary. The CD is indicated by the CD boundary. The camera view frustum indicates what an ADN's camera would see on the wall. In this embodiment, the ADN's camera field of view is larger than that of its projector.

FIGS. 11A-11E show various configurations of grouping the ADNs to create the CDs. Non-limiting examples of such configurations include: one CD made up of 2×2 projectors (FIG. 11A); one panoramic CD made up of 1×4 projectors (FIG. 11B); two panoramic CDs, each made up of 1×2 projectors (FIG. 11C); one CD using three projectors in a non-rectangular fashion, and another CD made up of a single projector (FIG. 11D); and one CD made up of 2×1 projectors, and two CDs made of a single ADN each (FIG. 11E).

FIG. 12 shows a non-limiting embodiment of three different desktops created using the collaborative nomadic displays framework.

FIG. 13 shows a desktop extension of the CD. The user can modify the data on his desktop which is reflected on the wall-top CD.

FIGS. 14A-14H are non-limiting examples of display driven data operations. In FIG. 14A, the user selects the F-16 using a laser pointer and selects the lower left screen as the destination to check out the model. In FIG. 14B, the F-16 model is now in a separate context on the lower left screen. In FIG. 14C, the user uses ADN reconfiguration mechanism to move it away—segmented from the display. In FIG. 14D, the model can now be edited without affecting the original data set. Here the model has been changed by rotating it 180 degrees. In FIG. 14E, the user moves the personal ADN back into the shared larger CD. In FIG. 14F, the changes to the model are now committed to the original data set. In FIG. 14G, calibration is performed. The calibrated CD with the latest changes is shown in FIG. 14H.

FIGS. 15A-15F show an example of a hotspot-based gesture recognition technique. In FIG. 15A, a user places hand over desired active display he wants to reposition. In FIG. 15B, the active display is selected. In FIGS. 15C-15D, the user moves the active display to a different position. In FIG. 15E, the user deselects the active display. The active display is now repositioned in FIG. 15F.

FIG. 16A shows QR® codes that, when placed without reshaping and resizing, created conflicts. FIG. 16B shows the reshaped and resized QR® codes placed without conflicts. The 4 projectors making the CD is shown by the outlined projector boundaries.

FIGS. 17A-17D shows non-limiting examples of laser based interaction. In FIGS. 17A-17C, the portable desktops on a display were made with four ADNs. FIG. 17A shows a paraview application that is used to interact with 3D brain data via laser based interaction. In FIG. 17B, the same interface is used for two people porting two desktops and interacting with different kinds of map data. In FIG. 17C, a keyboard is interfaced in addition to the laser. In FIG. 17D, the same interface is used on two LCD panel displays.

### DESCRIPTION OF PREFERRED EMBODIMENTS

Following is a list of elements corresponding to a particular element referred to herein:

101 display surface

102 display devices

103 sensors

104 display device

105 sensor

106 computing device

107 communications network

120 user

130 interaction device

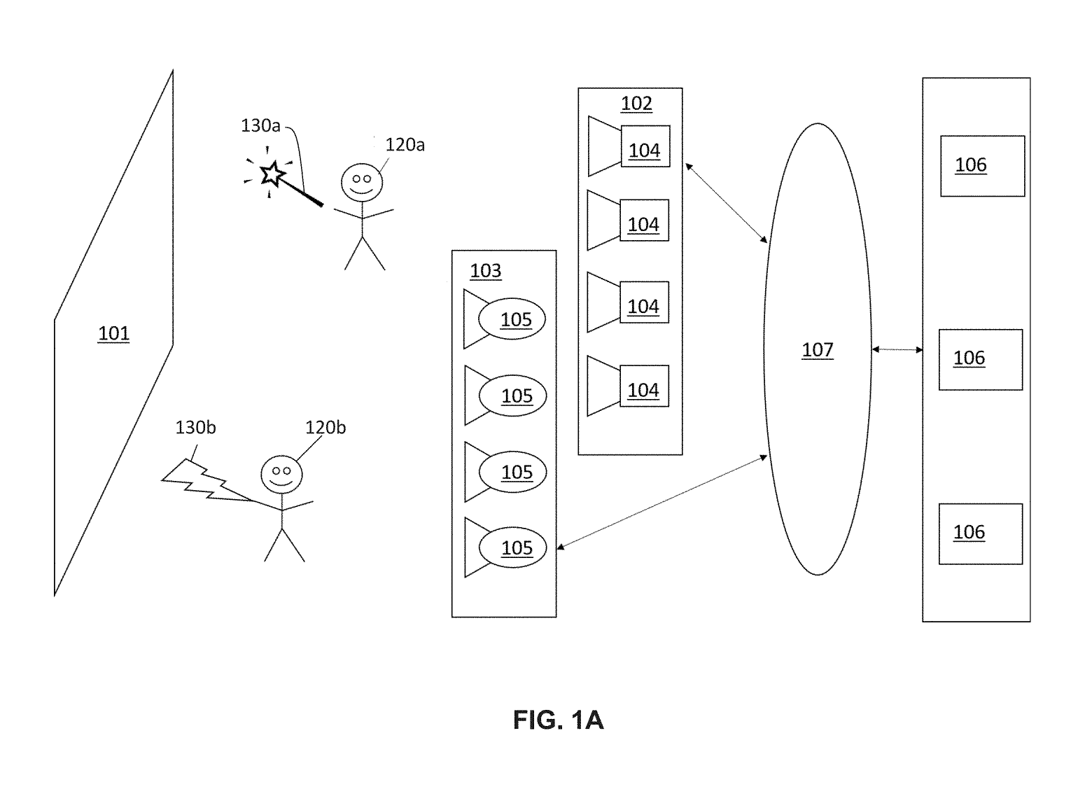

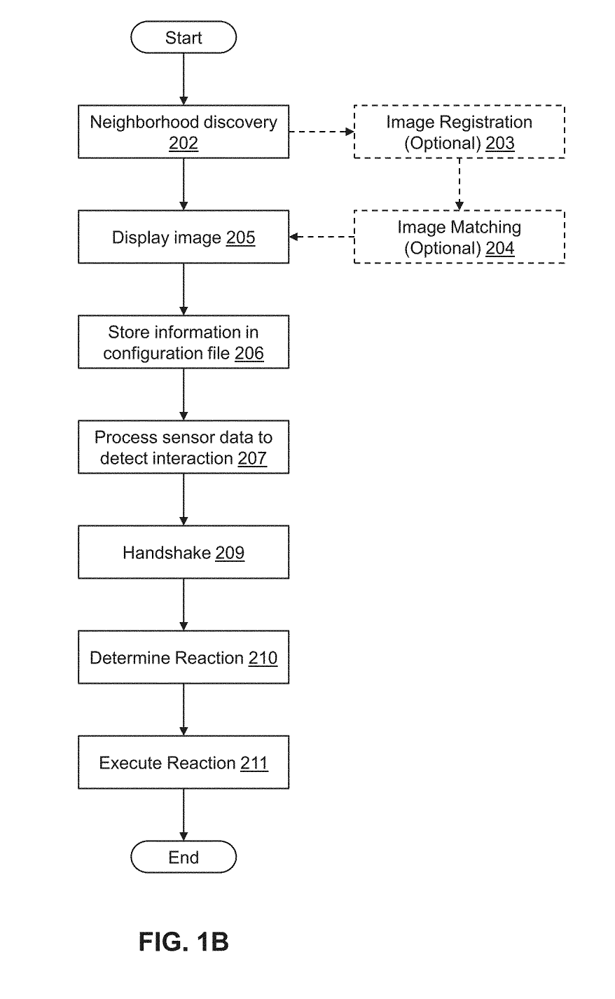

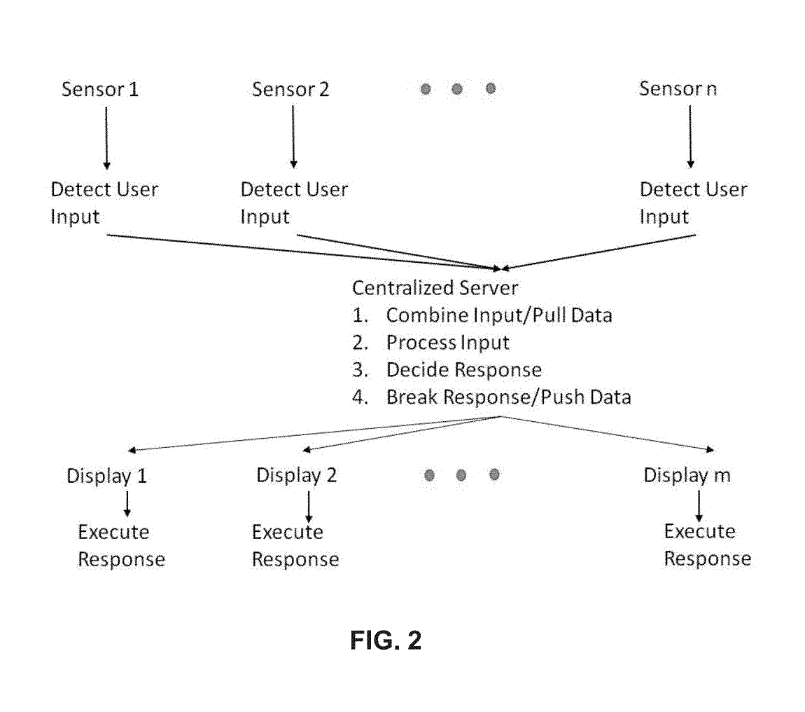

Referring now to FIG. 1A, in some embodiments, the present invention features a user interactive display system, comprising a display surface (101), wherein the display surface is shared by a plurality of display devices, one or more interaction devices (130), the plurality of display devices (102), one or more sensors (103), a communications network (107), and a network of computing devices (106). Each display device (104) is operatively connected to a computing device in the network of computing devices (106). The display devices are configured to display one or more images on the display surface. Each display device has a display field, wherein the display field comprises the shape and position of the portion of the display surface that the display device is configured to display upon, and each display device is configured to display a portion of the one or more images in their display field.

In some embodiments, each sensor (105) is operatively connected to a computing device in the network of computing devices. Each sensor may be capable of observing an interaction of the one or more interaction devices, wherein each sensor has a field of view. The interaction must be within the field of view of the sensor to be observed, and the fields of view of the one or more sensors are jointly disposed to observe the display surface.

In some embodiments, a communications network (107) sends communications between the plurality of display devices, the one or more sensors, and the network of computing devices. In other embodiments, the computing devices share a memory storage and processing time. In a non-limiting embodiment, the memory storage may be a non-transitory storage medium. In one embodiment, the memory storage may be a local memory or alternatively, a non-local memory, otherwise called a cloud, open storage, or cloud storage. In another embodiment, the computing devices share cloud resources such as computation time and memory. In some embodiments, the methods and processes described herein can happen in the cloud.

Referring to FIG. 1B, in some embodiments, one or more of the computing devices are configured to execute corresponding instructions. The corresponding instructions may be similar or identical. In one embodiment, the corresponding instructions which are computer readable instructions may comprise coordinating with the other computing devices to jointly display the one or more images seamlessly using the plurality of display devices, receiving sensor data from the sensors connected to the computing devices, if any, processing the sensor data to detect an interaction of the interaction device, communicating interactions to other computing devices, receiving interactions from other computing devices, determining a reaction to a user interaction, and executing the reaction to the user interaction. The plurality of display devices (102) may together project the one or more images on the display surface (101). A user (120) controlling one or more of the interaction devices (130) can execute an interaction with the display surface. The interaction may comprise one user interaction, or a plurality of user interactions which can be collectively referred to as an interaction. The one or more sensors (105) can detect the interaction, and the one or more computing devices process the sensor data to determine a user interaction. The one or more computing devices may also determine and execute a reaction to the user intent.

In some embodiments, each computing device (106) may be configured to execute the corresponding instructions comprising detecting a plurality of display devices connected to the computing device. For each display device connected to the device, the computing device executes instructions comprising detecting the neighboring display devices of the display device, communicating with the other computing devices to determine which computing devices are connected to the neighboring display devices, wherein the computing devices of the neighboring display units comprise the neighboring computing devices, determining the display field that the display device controls, determining the portion of the image the display device displays based on the display field that the display device controls, registering the portion of the image to the display surface, displaying the image; and communicating with neighboring computing devices to match the features of the portion of the image to the portions of the image displayed by the neighboring display devices.

In other embodiments, each computing device executes instructions comprising detecting one or more sensors connected to the computing device, determining the portion of the display surface observed by each sensor connected to the computing device, receiving sensor data from the one or more sensors connected to the computing device, processing the sensor data to detect an interaction of the interaction device, communicating interactions to other computing devices, receiving interactions from other computing devices, sending data to other computing devices, receiving data from other computing devices, determining a reaction to a user interaction, and executing the reaction to the user interaction. In some other embodiments, the one or more computing devices can communicate and receive one or more interactions from one or more of the other computing devices. The computing devices may be operatively coupled to one or more sensors that detect the one or more interactions.

In some embodiments, the one or more sensors may be jointly disposed to observe one or more interactions of the one or more interaction devices and jointly disposed to observe the display surface. In a non-limiting embodiment, such as human gesture based interaction for example, one or more dedicated sensors observe the interaction whereas another set of one or more dedicated sensors observe the display surface. In an alternative embodiment, the sensors may observe both the display surface and the interactions made on the display surface. Thus, the sensors may jointly observe interactions, or the display surface, or both the interactions and the display surface together.

In one embodiment, a few computing devices together handle only sensors, and a few computing devices together handle only display devices. In another embodiment, the computing device may have at least one display device and one sensor connected to it. Thus, one or more of the computing devices may be operatively coupled to only the sensors, or only the plurality of display devices, or both the sensors and display devices. In an alternative embodiment, the computing device may solely be used for computing, and not to control the display device or a sensor. Hence, one or more of the computing devices is not connected to any of the sensors or display devices. For example, this embodiment of a computing device may be operatively coupled to another computing device that is coupled to a sensor, display device, or both.

In some embodiments, the plurality of display devices (102) together projects a display image on the display surface (101). One or more users (120) controlling an interaction device (130) executes an interaction with the display surface. In some embodiments, determining the reaction to the user interaction may comprise determining a user intent. For instance, one or more sensors (105) detect the interaction, and one or more computing devices process the sensor data and determine a user intent from the interaction. The computing device then communicates the user interaction to other computing devices, and the computing device receives interactions from other computing devices detected by their sensors. The network of computing devices executes a reaction to the user intent.

In an alternative embodiment, the present invention features a user interactive display system comprising a display surface (101) that can be shared by a network of display units and one or more interaction devices (130) having an interaction mechanism. The network of display units (102) may comprise a plurality of display devices disposed in an array. The display devices are capable of displaying an image on the display surface. For example, each display device is configured to display a portion of the image and can communicate with each other to determine the portion of the image each unit displays and to match the image features to create a seamless image. Hence, the display devices together display the entire image.

In some embodiments, each display unit may comprise a display device (104) capable of displaying a portion of an image on the display surface, and a sensor (105) capable of detecting an interaction of the one or more interaction devices. The sensor (105) can have a field of view disposed to view at least the portion of an image displayed by the display device. The display device (104) may further include a communications transceiver (107) capable of communicating with the one or more interaction devices and the other display devices, and a computing device (106) operatively connected to the sensor, the display device, and the communications transceiver.

In one embodiment, the one or more computing devices can communicate the user interaction to other computing devices and receive interactions from other computing devices detected by their sensors. The computing devices may share a memory storage and processing time. In another embodiment, the network of computing devices may comprise a computing cluster that distributes the application data and processing across the computing cluster when a user interacts with an application.

In some embodiments, the computing devices of the network of display devices execute corresponding instructions. The corresponding instructions may be identical or similar. As a non-limiting example, the computing device may be configured to execute corresponding instructions that are computer readable instructions comprising detecting the neighboring display devices in the array, determining the display device's position in the array, determining the portion of the image to display, communicating with neighboring display devices, matching the image features of the portion of the image to be displayed to the portion of the image displayed by the neighboring units, establishing a communications link with an interaction device, receiving sensor data from the sensor, processing the sensor data to detect an interaction of the interaction device, interpreting the interaction to determine a user intent, receiving interactions and user intents from other display devices, receiving data from neighboring display devices, determining a reaction to the user event, and executing a reaction to the interaction and user intent. Consequently, the network of display devices (102) together projects a display image on the display surface.

In some embodiments, determining the portion of the image to display may comprise determining the overlap region between each display device's display field and the display field of the neighboring display devices, and aligning the content of the image portion with the content of the neighboring image portions in the overlap region. In some embodiments, the content of the image portion and the content of the neighboring image portions in the overlap region can be blended by color correction.

In one embodiment, a user (120) controlling an interaction device (130) can execute an interaction with the display surface. The display devices may execute a reaction to the user intent. The sensor (105) of the network of display units detects the interaction, and the display unit's computing device determines a user intent from the interaction. The computing device may communicate the user interaction to other display units and receive interactions from other display units detected by their sensors. In some embodiments, the arrangement of display devices, sensors, and computing devices that they are connected to may be configurable. The reaction to the interaction and user intent may comprise altering the configuration of display devices, sensors, and computing devices.

In some embodiments, the reaction may comprise altering the image displayed by the network of display devices. The computing devices can execute reactions to modify the portions of the image displayed by the display devices connected to them. In other embodiments, the reaction may comprise transferring data between a first device to a second device. In one embodiment, the first device and second device can be interaction devices or computing devices. In yet other embodiments, the reaction may comprise executing a program by one or more of the computing devices. The display image may be modified to display program data. In some embodiments, the program may be determined by the application. For example, a panning gesture can result in rendering of a colored line on the display for a graffiti application, and the same panning gesture may result in movement of map in a map visualization application.

In some embodiments, the display surface may be a curved, flat, or three-dimensional surface. In other embodiments, the display devices are video monitors or projectors projecting imagery on the surface. In still other embodiments, the display surface is made up of television screens or video monitors arranged in an array. The video monitors or screen may be LED or LCD based or any other type of video screen known in the art. In other embodiments, the display surface, the sensor, and the interaction device may be touch screens. In this embodiment, the user interacts by making a gesture on the display screen which is detected by the touch screen and transmitted to the computing device of the display device responsible for that part of the touch screen. In some other embodiments, the user interactive display displays a shared desktop. The desktop may comprise application icons with which the user may interact with the desktop to execute programs, manipulate data, and transfer data to and from their personal devices. The computing devices may collaboratively store the user and application data.

In various embodiments, the interaction device can be used to perform an interaction. In one embodiment, the interaction devices may comprise a plurality of different kinds of interaction devices. Non-limiting examples of interaction devices include a laser pointer, a tablet computer, a phone, a mouse, a touch screen, a keyboard, or even the user's own body, depending on the type of sensor in the varying embodiments. For example, the interaction device can be a user's body or part of a user's body such that the interaction mechanism is a body motion or gesture. Thus, the sensor of the display devices may utilize light detection and ranging (LIDAR). Non-limiting examples of LIDAR include 3D scanning devices such as Kinect®. In other embodiments, the sensor may utilize stereo photogrammetry to detect gestures. In some other embodiments, the sensor may be a camera that detects gestures, or a structured light source such as in Kinect®.

In one embodiment, the sensors may be cameras. Identification of the neighboring display devices may be performed by displaying an image identifying the display device on the display surface. The cameras record the images, and the computing devices process the camera's images to determine the arrangement of the display devices. In another embodiment, the sensors may comprise different kinds of sensors.

In other embodiments, the one or more sensors may be the one or more interaction devices. For example, instead of laser pointers, the users can wave cameras, and depending on what the camera sees, the gesture can be interpreted. The environment is not going to be observing the user interaction, instead, the environment is going to be passive, and the user with the camera is going to see the environment, and the system is going to react to what is seen, such as a QR code, a name plate, etc. In some embodiments, the user may wear a head-mounted camera, or grasping a hand-held/mobile phone camera.

In one embodiment, multiple different kinds of interaction devices are available to users. As an example, the interaction device may be a mouse and a keyboard which can be used to interact with a shared desktop. Thus, not all users may be using the same type of interaction device; instead, it can be a heterogeneous mix of interaction devices. For instance, some users may use laser pointers, while others can use mobile devices. In other embodiments, the interaction device is the user's body or part of a user's body, and the interaction mechanism is a body motion or gesture. In one embodiment, the interaction device may a laser pointer. Preferably, each user is assigned a unique color of laser pointer. In another embodiment, the interaction device may be a touch screen. The touch screen may be the display surface. The touch screen may also be the sensor of the display devices. Each display device may be operatively connected to the portion of the touch screen corresponding to the portion of the image they are displaying.

In some embodiments, the system of the present invention can differentiate between users or identify specific users. In some embodiments, certain applications such as, for example, games, annotations, etc, may implement user differentiation but not identification. In a non-limiting embodiment, differentiation can be achieved by using color lasers or colored labeling (stickers, markers, etc) on the hand or other body part. In another embodiment, identification may require codification, such as bar coding. Identification may be required in applications where there is a need to know exactly which user was responsible for an action, such as group education or prize giving for gamification.

In some embodiments, the interaction device may be a mobile device such as a tablet computer or phone. For example, the interaction device may be a mobile computing device. The interaction device of each user can be identified by a bar code that is displayed by or printed on the mobile computing device. The sensor of the display devices can view the bar code and the computer of the display device identifies the user by their bar code. In some embodiments, a non-limiting example of a bar code may be a QR Code®, which is a matrix barcode, or two-dimensional barcode. A QR Code®, or QR®, may comprise an image of squares arranged in a square grid, which can be read by an imaging device such as a camera, processed, and interpreted to extract the data from patterns that are present in the QR Code® image. As another example, the interaction device may be a tablet computer or phone capable of performing an interaction which establishes a link between the interaction device and one or more computing devices of the interactive display. The tablet computer or phone may have a bar code or marker imprinted on the back, allowing the computing devices to recognize the tablet uniquely. Alternatively, the QR code can also be displayed on a big display by one or more of the computing devices and can be read by the mobile device to get connected to the display.

In other embodiments, the interaction device may be identified by an internet protocol (IP) address. The IP address is transmitted to one or more of the computing devices, which stores the IP address of each connected interaction device. In yet other embodiments, the interaction device may be identified by user credentials. For example, the user logs into the system using his or her user credentials, and the interaction device communicates the user credentials to one or more of the computing devices.

In some embodiments, each computing device of the network of computing devices can store one or more configuration files for each display device it controls. The one or more configuration files may comprise one or more information about the neighboring display devices, neighboring computing devices, display surface, image portion, image registration and image matching features of the display device.

In other embodiments, the interaction device may be a computing device that is connected to the network of computing devices via the communications network. The interaction device can receive one or more configuration files of each display device, preprocess the image to partition and correct the image data for each display device, and send each display device the partitioned and corrected portion of the image they should display. One or more of the computing devices can display the partitioned and corrected portions of the images they received, so that a complete image is displayed on the display surface.

In some embodiments, the interaction and reaction may comprise a transfer of data between multiple user devices. A first user interaction may be used to push data from a user's device to the network of display devices, and a second interaction may pull data from the network to a second user's device. In another embodiment, the reaction comprises modifying the image displayed on the multi-display, for example enlarging the image, panning, zooming, or rotating a 3-D image, or editing the image.

In some embodiments, the network of display devices can operate together as a shared computer or computer cluster. Each display device can have a computer processor which comprises storage space and computer applications. In some embodiments, the computers can communicate with each other to collaboratively store data in a cloud formation. The computers can execute instructions by users to utilize various software programs available on the various computing devices.

In some embodiments, the interactive display may comprise a shared desktop. One or more of the devices may be executing a user interface which displays a desktop with various icons. The user interactions may comprise manipulating the desktop in the same manner as a personal computer.

In an exemplary embodiment, the invention may be used in the classroom for education. An interactive display wall in the classroom can be used by the teacher to push, say, problems from her tablet on to the wall. This can then be picked by different students from the wall. Their work sessions can be visible to the teacher on the wall as they continue to work. The students can use wireless network, or come to the wall and post their partial solutions from time to time for other students to see. The teacher can enlarge any of the work sessions to point out mistakes or to show examples of elegant solutions or good work.

In another example, a group of art students may develop art in their personal devices and post it in different places on the interactive wall, move scale and rotate to create a collage using conglomeration of art from multiple students. Students can pick art pieces of other students from the wall in their tablet and change the picture to facilitate better collage creation.

In one embodiment, multiple users can work on appropriate annotation of a big data (e.g. map) display wall and paste them in appropriate location on the wall. In another embodiment of a system, a single user can interact with a single projector with a single laser pointer pointing at the projector screen detected by a single camera communicated via Bluetooth mechanism resulting in reaction of zooming in and panning through presentation slides. In yet another embodiment, multiple desktops may share real estate for displaying personal desktops on a large multi-display, each desktop pulling and pushing data to a specific region of the display.

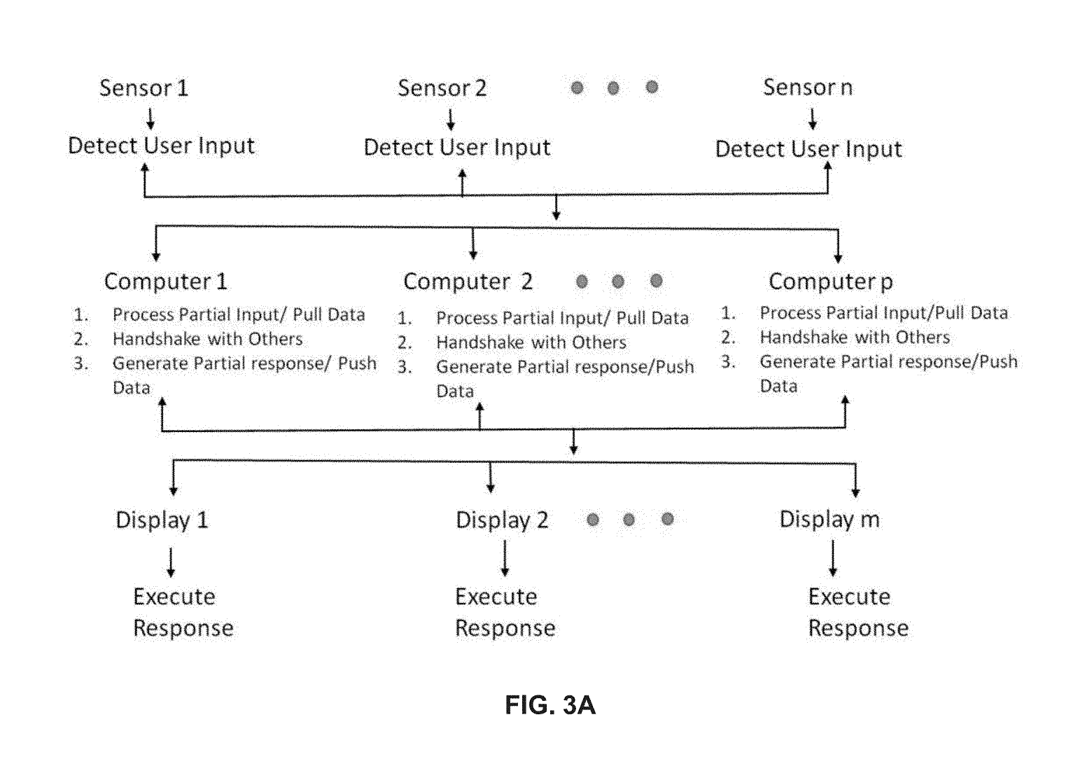

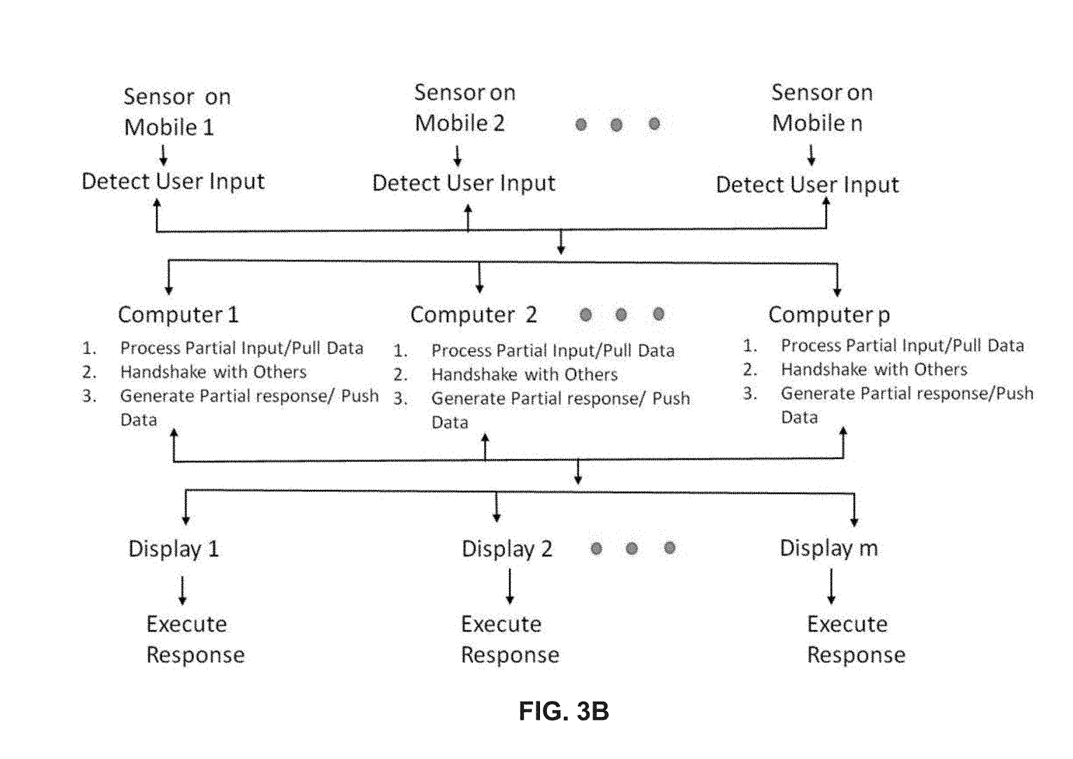

As shown in FIG. 3, the prior art utilizes a centralized server that combine inputs and break down responses for multiple sensors and displays. As used herein, sensors include cameras, such as IR cameras, and displays include projectors and multi-LCD panels. The sensors and displays are not limited to the aforementioned examples. The displays combined form a multi-device display which should act like a single interactive display with the user. In contrast, as shown in FIGS. 3A-3B, the present invention features a system that includes one or more number of cameras, computers, and displays. The computers of the system process partial inputs and generate partial outputs, thus, there is no combination and breaking. The sensors, computers and the displays may be connected via a network, such as, for example, a LAN or cloud network. The displays combined form a multi-device display which acts like a single interactive display with the user. The input may be physical or hand gestures or laser pointers or QR Code® on mobile devices. In some embodiments, a subset of displays or sensors may be involved. A set of sensors that sees the input need not be the same in number as the set of displays that execute responses.

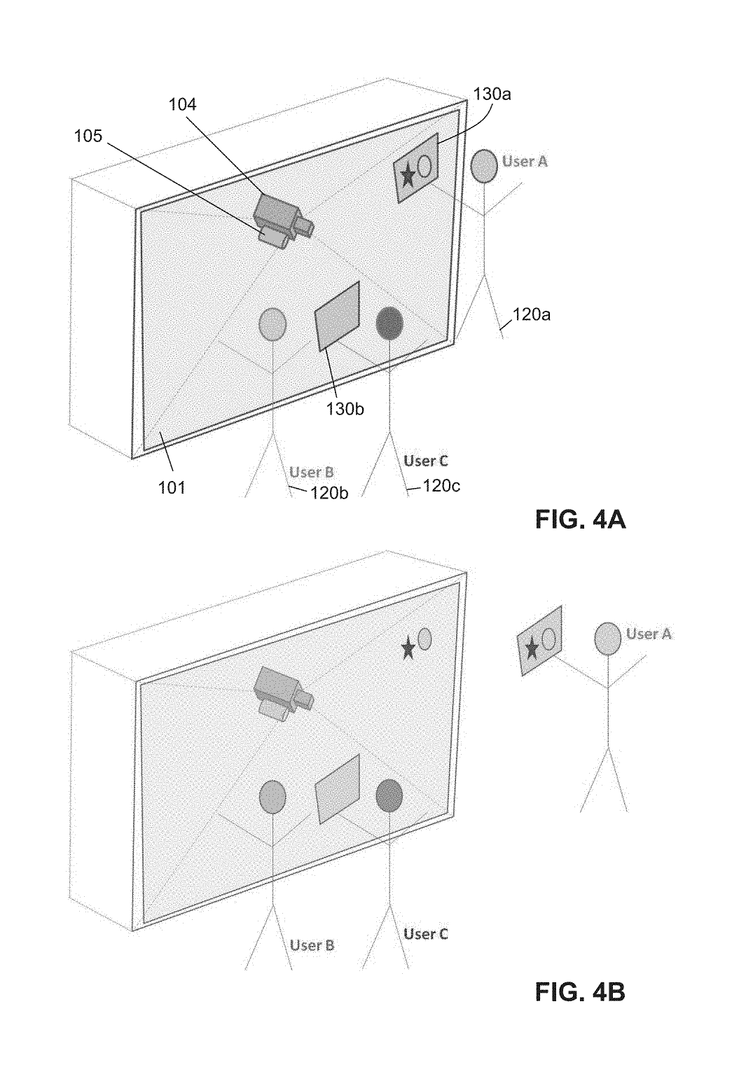

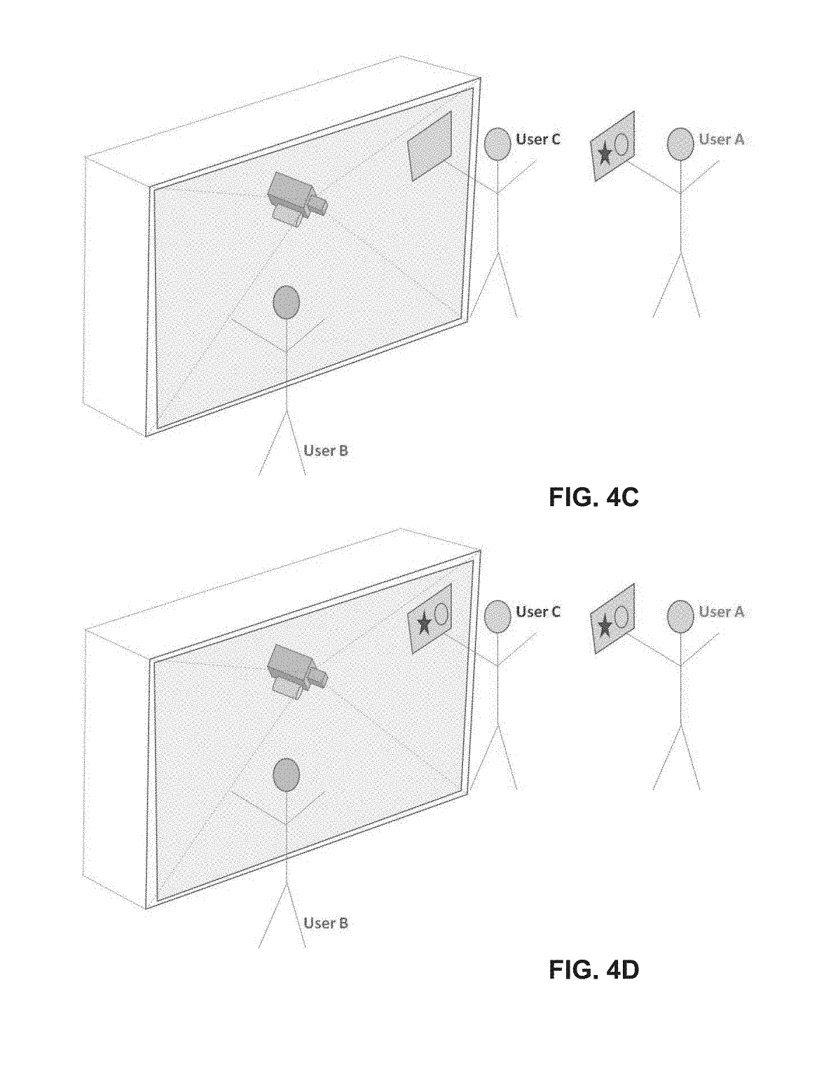

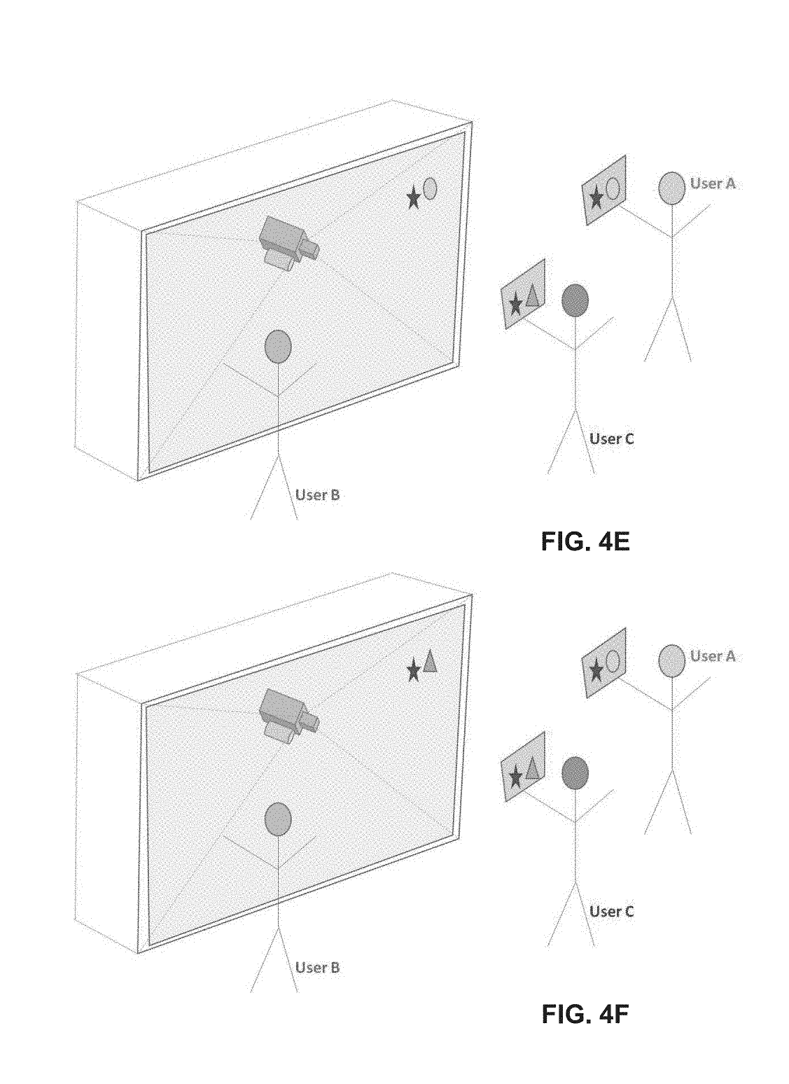

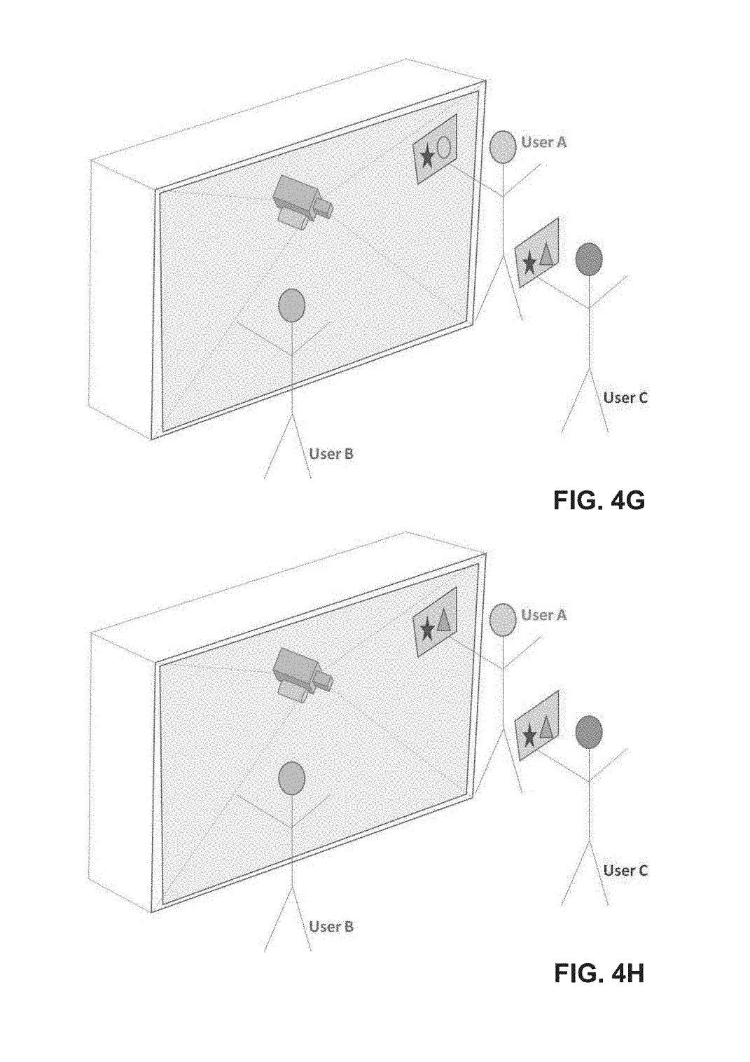

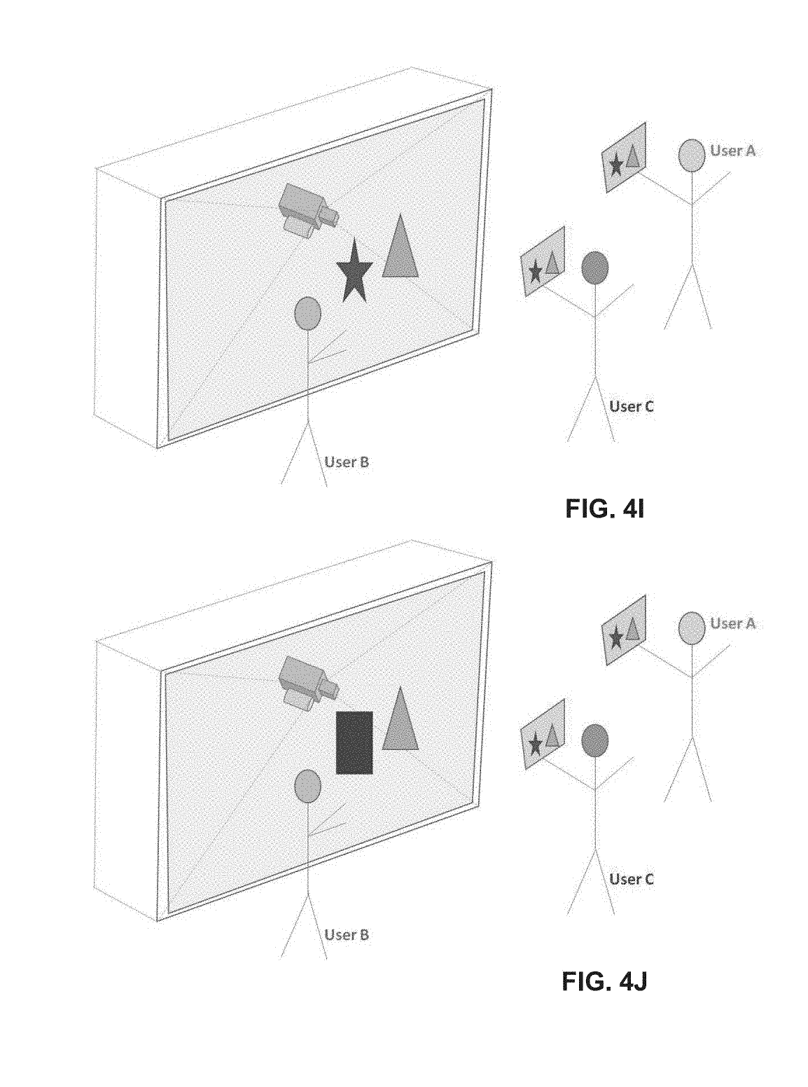

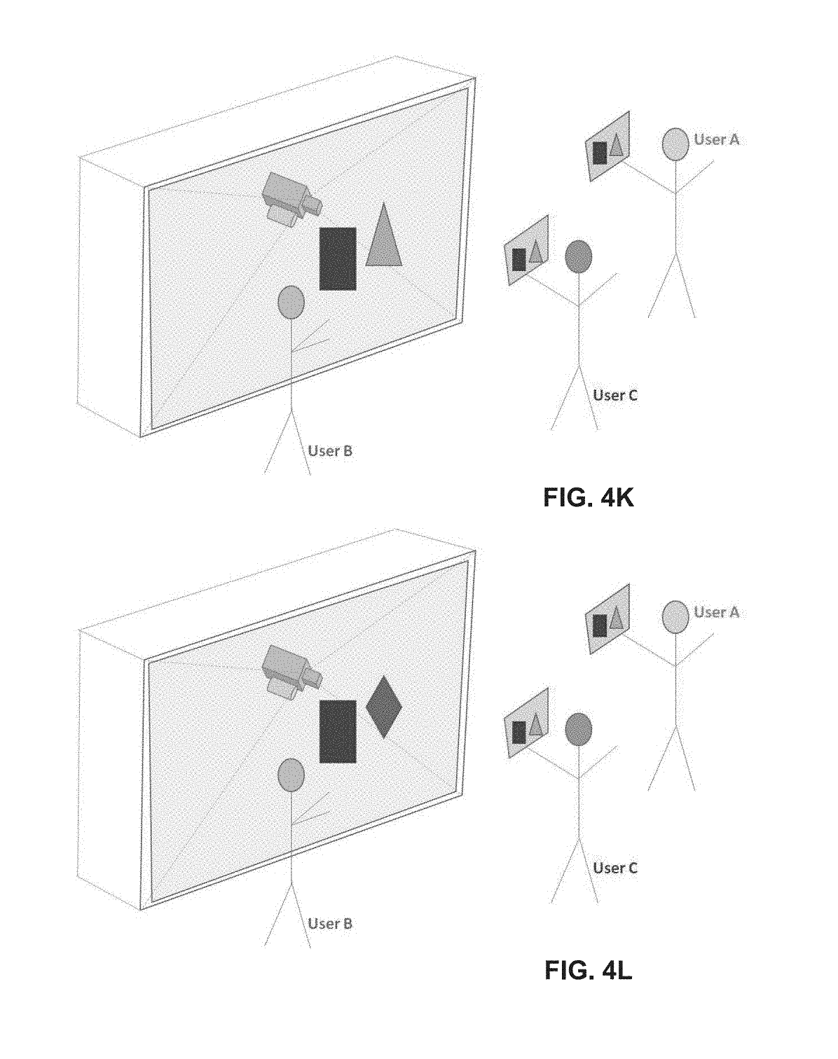

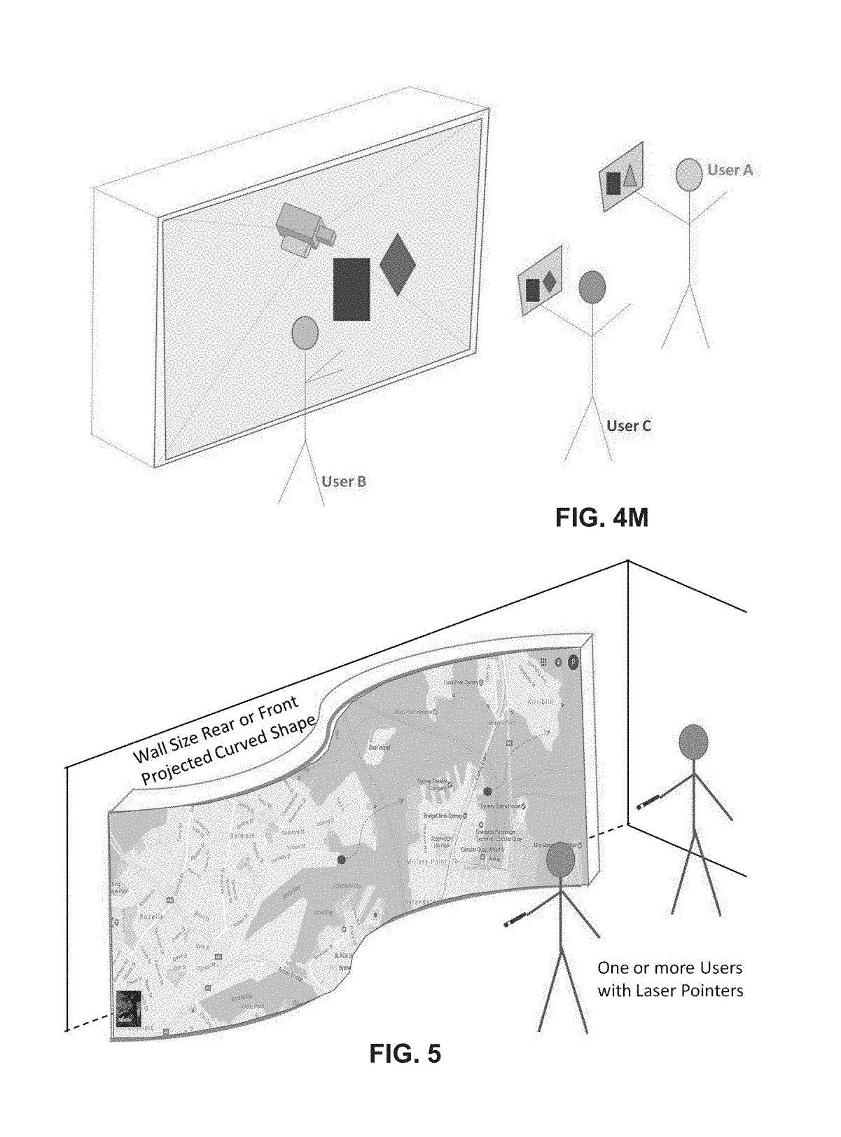

In one embodiment, the use of the interactive multi-display is exemplified in FIGS. 4A-4M. Referring to FIG. 4A, User A takes his tablet which is appropriately augmented with a code encoding relevant communication parameters and presses it against the interactive display. In FIG. 4B, the establishment of the communication between the tablet and the interactive display. The display detects the code, and establishes a communication channel via any wireless network being used to communicate amongst the computers using which it pulls the content of the tablet on the display. The tablet remains in communication even if User A moves away from the display. User C comes and presses his tablet at the same location (FIG. 4C). A communication channel established between the display and User C and the content of the display is pulled on to the tablet of User C (FIG. 4D). FIG. 4E shows that User C now moves away from the display and changes the content on his tablet. In FIG. 4F, since the tablet of User C is still communicating with the display, the change shows up on the display. This change may happen even without touching the tablet to the screen if a protocol for managing tablet association with regions of the display is maintained. In the absence of such a protocol, simple touching can initiate the process. FIG. 4G shows that User A presses the tablet against the wall. In FIG. 4H, since User A is still connected to the wall, he can pull the content on the wall on his tablet.

FIG. 4I shows that any user, like User B, can now move and enlarge the content on the wall for other purposes like explanation or illustration. User B can also change the content (FIG. 4J). In FIG. 4 K, since the tablets of Users A and C are still connected to the display, the change shows up on the tablet. Such changes can also be implemented via user privilege management. For example, the change made by User B can be pushed to Users A and C's tablets only if User B is a supervisor. FIG. 4L shows that User A can disconnect his device from the display so that his content will remain unchanged. In FIG. 4M, User B can change the data on the display and User A's device is no longer affected.

### EXAMPLES

The following is non-limiting example of the present invention. It is to be understood that said examples is for illustrative purposes only, and not intended to limit the invention in any way. Equivalents or substitutes are within the scope of the invention.

The following example features a system implemented via the conglomeration of the display space of one or more steerable display devices, each made of a projector and camera mounted on a pan-tilt-unit (PTU). In the underlying architecture design, the display space made of n displays is segregated from the backbone of clusters of m machines in which the data resides. This allows the n displays to connect to the m machines in a network configuration which can be reconfigured from time to time based on the data flow and data requirement of multiple user groups in the workspace. The system of nomadic displays is empowered with the design and implementation of a framework for porting desktops on multi-displays and interacting with them using multiple modalities.

System Overview

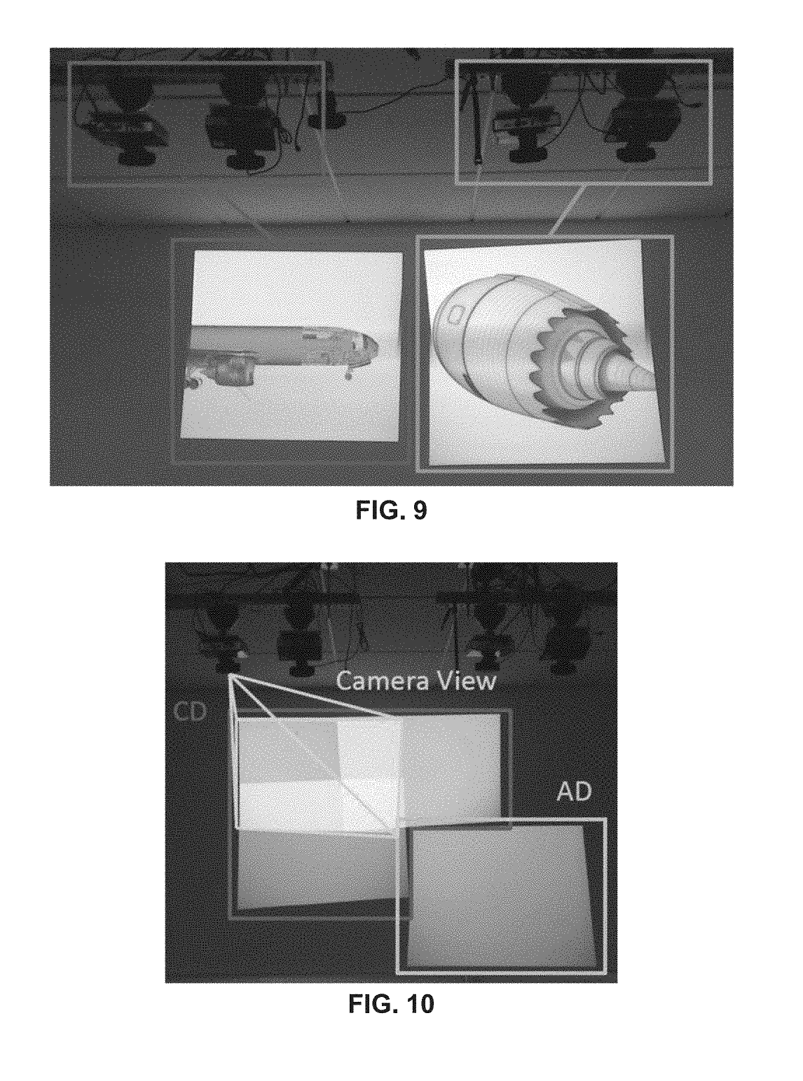

The nomadic displays paradigm of the present invention comprises a conglomeration of active display nodes (ADNs) mounted on the ceiling of the workspace. Each ADN consists of a projector and a camera. In some embodiments, the ADN may be optionally mounted on a pan-tilt-unit (PTU). All the ADNs are then mounted on rails that extend from the ceiling of an office, as shown in FIGS. 9-10. The camera field of view (FOV) in an ADN is assumed to be reasonably larger than the projector FOV. This assumption is derived from the common FOVs available in commodity cameras and projectors. This conglomeration of n ADNs is connected via a network to a cluster of p compute units or PCs. Each ADN is connected to a computer (can be the PC of one of the users in the open workspace) and more than one ADN can connect to the same computer. Therefore, the backbone architecture of the nomadic displays is very loosely coupled to the cluster of PCs that drive conglomeration of ADN. The connectivity between the m ADNs and n PCs can be reconfigured on demand.

In preferred embodiments, each ADN may be capable of movement. In one embodiment, ADN movement may be achieved by the PTU, which can orient itself in any configuration thereby pointing the projector at any place in the office. In other embodiments, the ADN movement may be achieved by other mechanisms including, but not limited to, moveable pedestals or poles or struts behind a screen. Thus, a display can be placed anywhere in the workspace to create a display space. In a non-limiting embodiment, the nomadic display may hang from ceilings. In another embodiment, the nomadic display can be used in a theater lobby or a mall or museum exhibit. Unlike works that assume a flashlight metaphor, underlying virtual data that is assumed to be statically residing on the real estate or a shared workspace is not illuminated.

The system provides a scalable mechanism to create displays of any size, form factor and resolution. When an ADN is positioned contiguous to others, the system creates a larger seamless display by aggregating all spatially contiguous ADNs, effectively increasing the size and resolution of the display. This grouping of ADNs is referred to herein as a conglomerate display or CD (FIG. 10). With this capability, users are able to move the ADNs around to form a smaller individual workspace or to join the ADNs together to create one or more CDs of different size and form factor. Therefore, this paradigm is called nomadic displays where each ADN is a nomad and can join in any CD as per user(s) demand.

Interaction for Display Reconfiguration

Displays in personal computing environments (e.g. PC, tablet, phone) today are becoming of such small form factors that they cannot be used in an ergonomically comfortable and functionally efficient manner for long collaborative sessions. On the other hand, people are comfortable sharing a larger physical space (e.g. a meeting room, or a table surrounded by chairs in a big workspace) for collaborative dialogue and discussions using devices of much larger form factor like white boards and smart boards. So, it is imperative that if the users are provided with the capability of bringing such a larger form factor display anywhere in their shared physical space, they will be encouraged to use this for collaborative purposes. The present system therefore provides interaction capabilities by which the user can move the ADNs using gesture or a laser, and connect them together in different configurations by the simple mechanism of placing them in a spatially contiguous fashion. These different configurations include changing the number, position and configuration of the ADNs forming the CDs that changes their size, resolution and form factors accordingly. This allows users to have a set of displays that can change over time based on the specific need of their application.

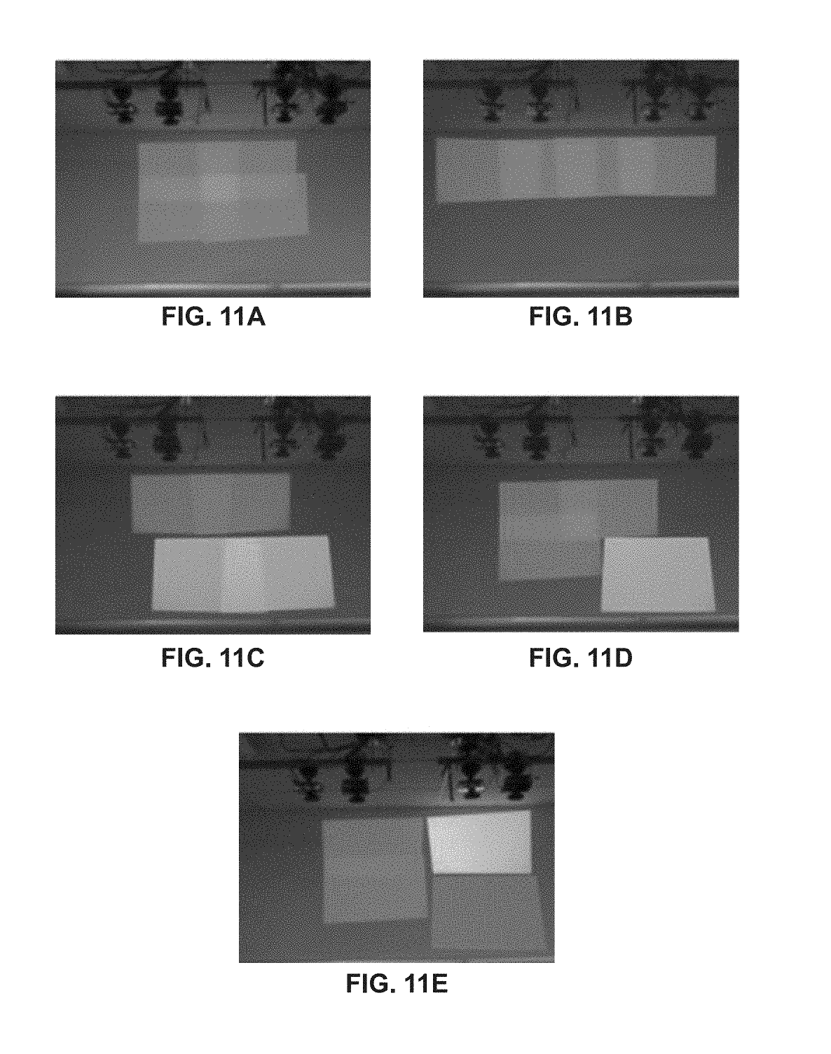

For example, a few users may be using a large display of 4K resolution to visualize a large 3D model. When they each want to check out a different part of the model for editing, they can segment the display into three: (a) one of 2K that still shows the whole model; and (b) two other displays, each of 1K size can be segmented away from the 4K display to create two smaller environments for the users to edit the respective model parts they have checked out. Once they are done with editing, merging the personal 1K displays with the 2K shared workspace commits the changes to the main model and brings back the 4K shared display. Referring to FIGS. 11A-11E, this kind of branch-explore-merge paradigm of interaction is effective for collaboration and is only possible when the user has extreme flexibility to reconfigure the multiple ADNs into different number of differently sized and shaped CDs. The different colors indicate the system identifying the different CDs by their conglomeration via spatial contiguity. This is referred to as interactions for display reconfiguration.

This interaction is enabled by the camera on each ADN that provide visual input to trigger movements of the PTU to move the display around. Users can use a laser pointer or hand gesture to achieve the movement and hence the reconfiguration. To alleviate the user from situations of making complex decisions like (a) are the displays connected or segmented with or from each other or (b) do they have enough overlap to create a nice seamless display, the system provides intuitive visual feedback. When the user selects an ADN to move, it is highlighted as white. When the user starts moving an ADN, the boundaries of all other ADNs are highlighted with red. As the user moves the ADN, its white projection allows tracking of the ADN. Once the ADN enters the display space of another ADN, it can compute its overlap with the moving ADN well defined by its red highlight. Once this overlap is beyond a threshold, the boundary of this ADN turns green to indicate to the user that enough overlap has been achieved. Once the user has reached the desired configuration, the system runs an automated registration to identify and register the imagery coming from multiple ADN units into one or more seamless CDs.

Interaction for 3D Manipulation

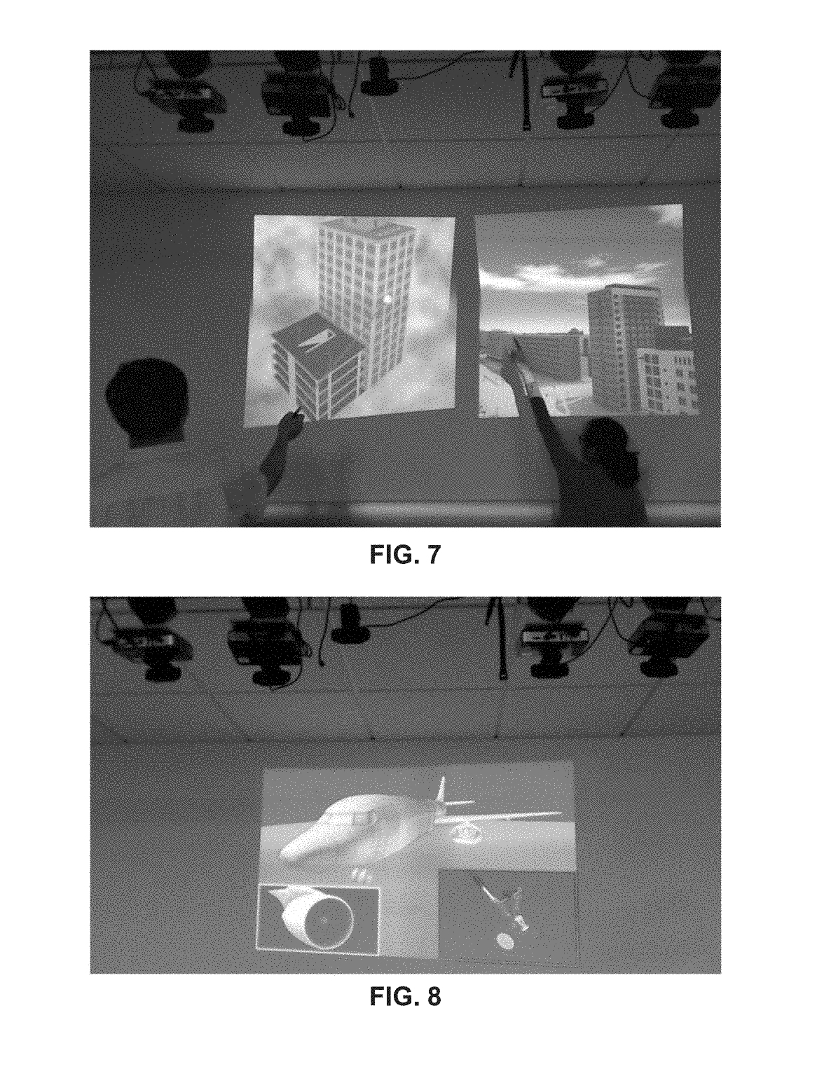

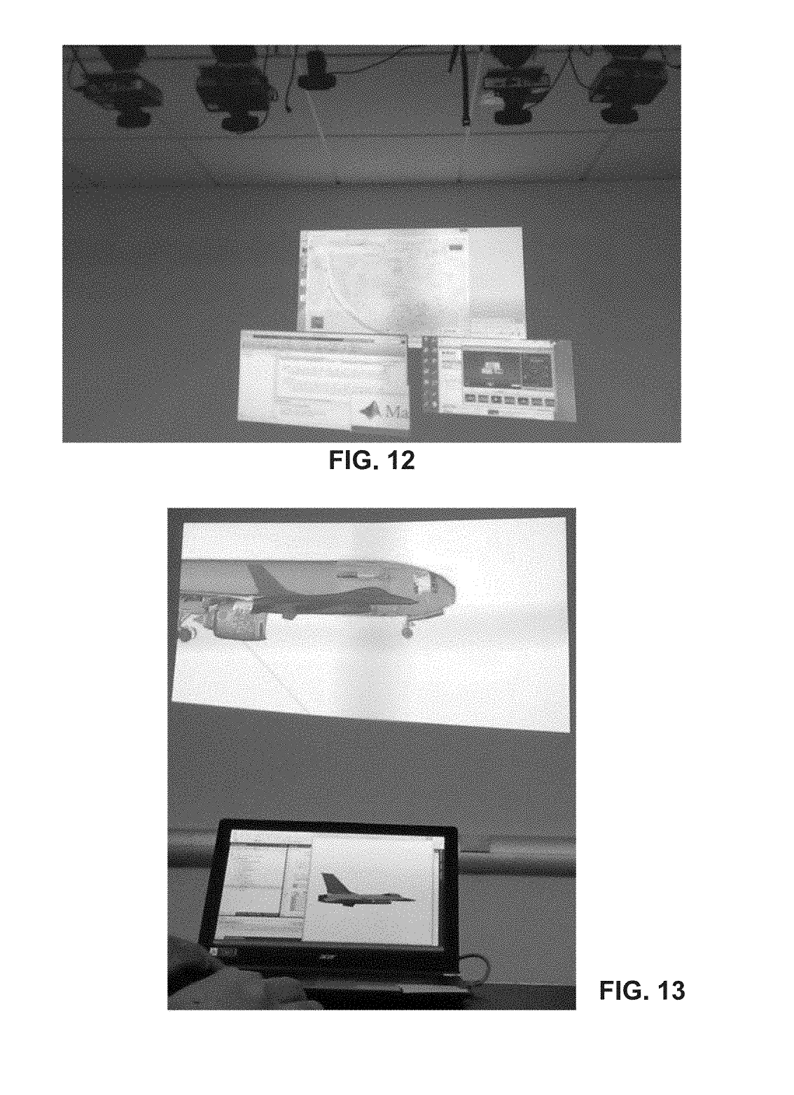

The first capability of a collaborative system is to allow users to connect to the shared display easily. The portable desktop interface allows one or more users to connect to a CD and port the whole or part of their desktop on the CD. As shown in FIGS. 7 and 12, the position of their desktops on the conglomerate display can be easily moved around using a laser pointer or a control interface

In a walkthrough 3D environment, the user can use various types of inputs to navigate through the environment. A laser pointer based interaction mode is implemented, which defines three types of movement: forward/backward, rotate left/right, and pan up/down, and tied them to different laser-based gestures. To move forward/backward, the user creates a straight line from the bottom to the top portion of the CD and vice versa. To rotate left/right, the user creates a straight line from the left to the right portion of the CD and vice versa. To pan up/down, the user creates a diagonal line, where a line direction between 20 degree and 70 degree is interpreted as a pan up and a line direction between 200 and 250 degree is interpreted as a pan down. These movement operations allow the user to fully explore the 3D dataset. However, such interactions can be designed for this and any other application as per the users' specifications using the interface modality (e.g. hand gestures instead of laser based gestures) he chooses.

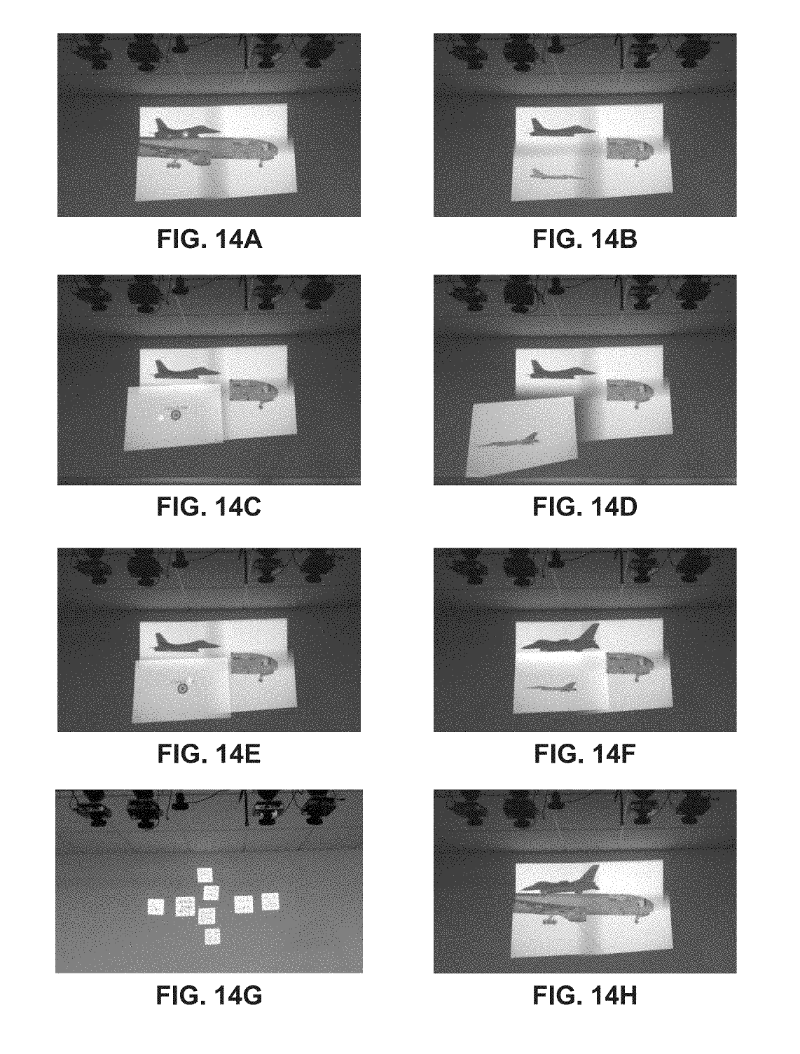

Display driven data operations may be performed, such as data check-out, edit and commit step for shared 3D data manipulation avoiding data inconsistencies as per the branch-explore-merge paradigm. The user can trigger checking out of a part (e.g. engine of a plane) of a bigger 3D model being visualized collaboratively via a few blinks from the laser pointer. This part then can be moved to a smaller part of the display which can be segregated out from the bigger display using the same mechanism for repositioning the ADN, thus allowing the user to edit the part of the model on his own without disturbing the shared model visualization. Once done with his edits, the user moves the segregated display back towards the bigger display triggering both a merging of the displays and a commit to merge his changes to the data which shows up in the shared collaborative visualization. This is illustrated in FIGS. 14A-14H. Referring to FIG. 13, the same paradigm allows the user to treat his own desktop display as an extension of his shared CD and make changes there which are reflected in the wall-top CD.

Front-End Processes

Several front-end processes work together to achieve the interaction for display configuration and for 3D data manipulation.

Interaction for Display Reconfiguration

The ADNs are considered as a set of active agents that are working together to create the nomadic displays. Therefore, a distributed methodology was developed for grouping and regrouping of the ADN's to create the conglomerate displays (CDs). This allows easy addition and removal of the ADNs to the pool of nomadic displays. The output for this process is a configuration file for each ADN—that any application can use to understand the configuration of the CD. Each configuration file contains its IP address, a list of the ADN's neighbors and their IP addresses, and the geometric transformation to warp the 2D image from the ADN into the display space. With each reconfiguration, the configuration file of the affected ADN is changed.

An API is available for developers to create their own applications that can be integrated with the system. A user can query the system for the configuration information from each ADN. When the system starts up, the position, orientation and ID of each ADN is unknown. In fact, each ADN does not even know the number of total ADNs in the system. The ADNs have to go through a process of making themselves known to the system. For this purpose, a distributed registration technique was adapted for registering a single tiled display made of a rectangular array of projector-camera units projecting on a planar display. In this system, an algorithm runs on each unit that starts with the assumption that it is the only unit in the environment. Then it performs a configuration identification step that goes on to discover all the other units, its own location and the location of its neighbors in the rectangular array. Finally, in a registration step, the algorithm achieves seamless registration of all the images from the multiple units. This method assumes rectangular overlaps of roughly fixed widths and achieves the configuration identification and registration via one or more QR® codes placed on these similarly sized overlaps. In some embodiment, the algorithm on each computer may be similar programs. In other embodiments, the algorithm may be an r (single program multiple data) algorithm that is an identical program on each computer.

In some embodiments, the nomadic displays paradigm faces the following challenges: (a) The projections show considerable keystoning that cannot assure rectangular overlaps; (b) Since the user is given complete freedom to overlap ADNs with each other as they please, similar sized overlaps or overlaps strictly to the left, right, top and bottom of each unit cannot be assured, and (c) if the user does not provide adequate overlap, the system needs to guide the user to provide adequate overlap. To allow for these additional flexibilities, the system implements the following additional steps before the configuration identification and registration steps can take over. These steps for each ADN are (a) Overlap Discovery; (b) Placement Feedback; and (c) Conflict Free QR Code® placement. The larger FOV of the camera in an ADN assures that it sees its own projector and parts of the neighboring ADNs as well.

Overlap Discovery—In a non-limiting example of the present system, the display surface may be a flat display. In this case, the goal of this step is for each ADN to identify the overlap regions around its boundary, their size and shape so that it can achieve a conflict-free QR Code® placement. For this, as soon as each ADN is powered on, it projects a white image and observes it. Note that if none of the ADN's overlapping neighbors project at the same time, the larger field of view of the ADN would see only one white display surrounded by a dark or dimly lit (if some ambient light is present) region in all directions. Further, when any of its neighbors projects the white, it should be able to observe it through the larger field of view camera to detect the overlap, its shape and size. It assigns the overlap to be a left, right, top or bottom one based on the largest number of pixels present in its four quadrants. For example, if the overlap has more pixels in its top right than bottom right quadrant, it is assigned as an overlap on the right of the ADN. In order to handle conflicting projections from multiple ADNs at the same time, an algorithm is proposed in which any ADN trying to project at any time first senses if a neighboring ADN is projecting via the camera by detecting the presence of a white area sharing the boundary of the ADN. The ADN projects only if another ADN is not projecting in its area. Otherwise, it waits a random amount of time and retries. This continues until all ADNs construct their overlap areas and label them as left, right, top and bottom. Finally, each ADN computes a rough homography that relates itself to the different ADNs having overlaps with it. This is achieved as a two step process. First the i^{th} ADN discovers the four corners of its own projection in its camera space to find the homography H_{Pi→Ci}; from its projector space to the camera space. Next, it finds the four corners of the overlap with a neighbor j to find the homography between the camera in the i^{th} ADN and the projector in the j^{th} ADN, given by H_{Ci→Cj}. These two homographies are then concatenated to provide an homography between the projectors of the i^{th} and j^{th} ADNs, i.e H_{Pi→Pj}=H_{Pi→Ci}H_{Ci→Pj}. These homographies are approximate since they are computed using only four correspondences.

It is to be understood that the aforementioned non-limiting example of homography is relevant for flat displays. In other embodiments, different methods may have to be used for non-flat displays. Non-limiting examples of overlap discovery for non-flat displays may feature methods that involve cross validation of device parameters are partial surface reconstructions.

Placement Feedback—In some embodiments, the interaction may be used to change the configuration of the display. In a non-limiting example, for interaction for display manipulation, a mechanism for the user to move displays around is provided. This can be done by a laser or hand gesture (open palm). Once the ADNs are powered ON, the user can use gestures to position them the way he wants to create the CDs. Every ADN has a designated hot-spot-switch area. If a gesture is detected in this area, the ADN switches to reconfiguration mode. The user starts with a gesture in this switch-hot-spot area of the ADN he desires to move. The ADN turns white to indicate its status of being chosen to be moved. A broadcast message lets all the other ADNs know of the existence of a moving one and they turn their boundaries red. When the user moves the selected ADN, the white projection allows continuous tracking of the moving ADN via updated H_{Pi→Ci}. As this moving ADN enters the field of view of any other ADN, it can track the overlap easily due to the red boundary and computes the amount of overlap in the projector space using H_{Pi→Ci}. If this overlap is above a threshold, the observing ADN turns it boundary green to indicate enough overlap. Therefore, the user has to make sure that whenever he is merging, all the ADNs he is merging with should turn green. While segmenting the display, visual feedback is of less use since all the user needs to do is to make the moving ADN spatially disconnected from the existing CD. Once the user finishes moving the ADN, another gesture in the same switch-hot-spot area moves him out of the reconfiguration mode. Since relative position of the projector and the camera in a single ADN does not change with movement, the location of the hotspot remains the same across this movement.

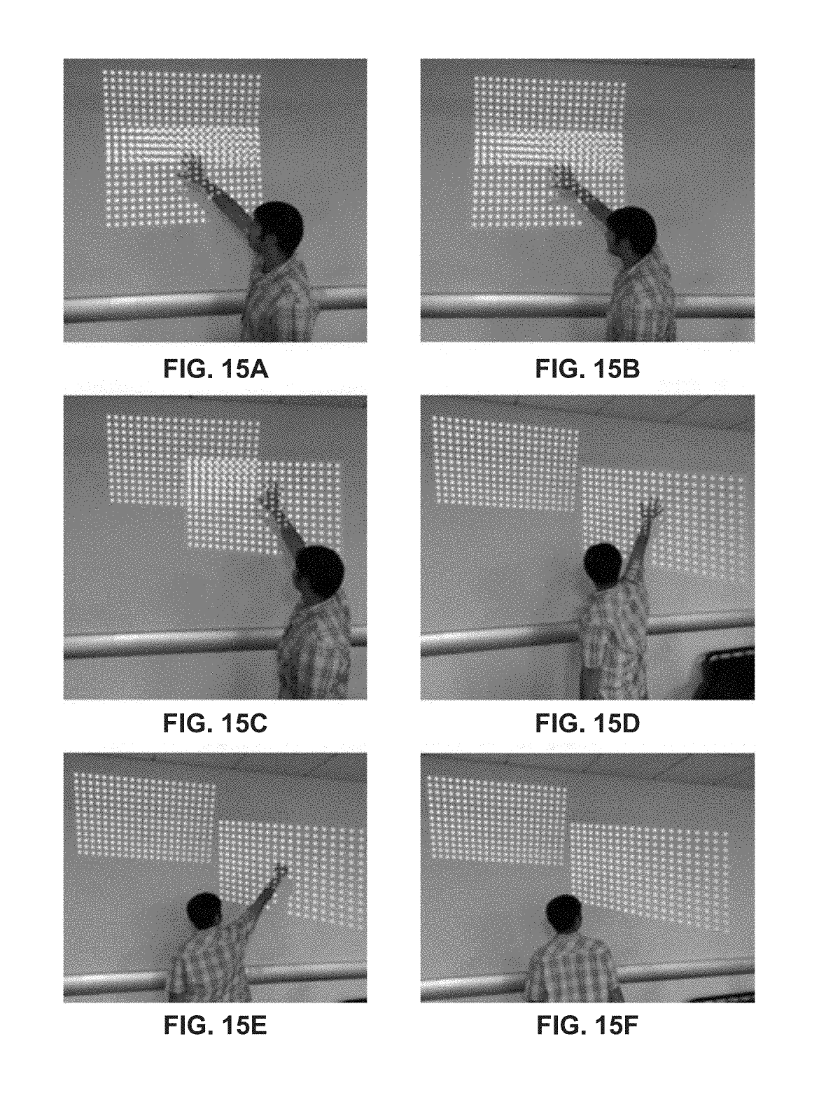

To move the ADNs intuitively, the projected area from the ADN should move along with user gesture. This demands a fast and simple interaction recognition and tracking. For laser-based interaction, a simple and fast image processing is used to detect the laser highlight and move the ADN quickly with it. Referring to FIGS. 15A-15F, the steps of this method are as follows: (a) Point the laser to the switch-hot-spot area to switch the mode; (b) a red circle appears on each ADN; (c) select the ADN by holding the laser on this red circle of the desired ADN; (d) the selected ADN turns white and the other ADNs display red boundaries; (e) move the ADN using the laser and the movement stops when the ADN(s) with which it is merging turns their boundaries green indicating sufficient overlap to create a seamless CD; and (f) point to the switch hot-spot to switch away from the reconfiguration mode.

Achieving the movement of the ADN with the hand gesture is computationally very demanding, probably close to real-time, process. Since the user is not engaged in any work on the displays during this phase of configuring the conglomeration, we a much simpler hotspot-based gesture recognition technique may be used. This greatly increases the accuracy of gesture recognition at a very low latency allowing the ADN to move along with the user. The steps of this method are as follows: (a) change from display mode to reconfiguration mode by placing palm on switch-hotspot area; (b) project blob pattern in the display space; (c) identify the open hand gesture used to select the desired active display; (d) track the movement using hotspot-based tracking and move the active display to a different region; and (e) if there are no movement for more than 3 seconds, identify that as the culmination of the reposition operation, and deselect the active display switching out of reconfiguration mode.

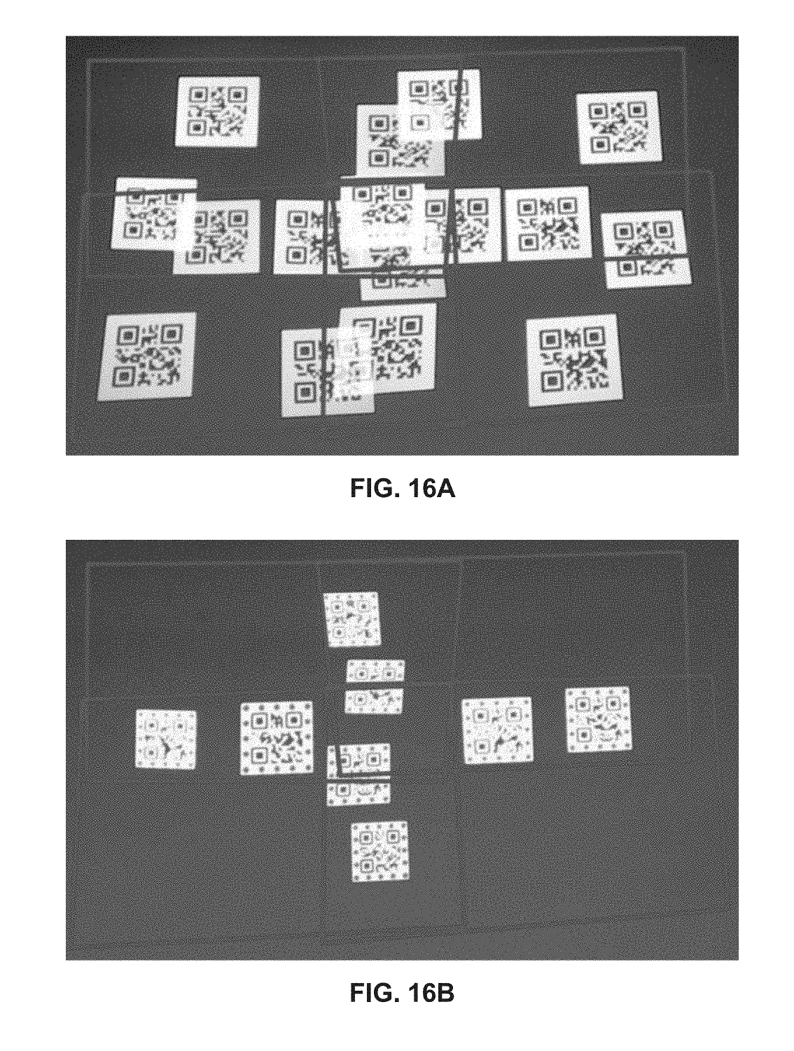

Conflict-Free QR Code® Placement—In nomadic displays, the overlaps are most likely to be all trapezoidal due to key-stoning and can be differently shaped and sized. This leads to two issues: (a) a rectangular QR Code® in the projector coordinate system results in a trapezoidal QR Code® on the display which cannot be detected using standard QR Code® detectors due to severe resolution compression in some of its regions; and (b) a standard placement of QR® codes can overlap or conflict with the QR Code® from another ADN. Thus, the system introduces two steps to alleviate this situation. First, the approximate homography H_{Pi→Ci}; computed in the previous step is used to apply a pre-warp to the QR® codes so that when projected the QR Code® looks rectangular. Second, the size and placement of the QR Code® is selected using the method of Algorithm 1 to achieve a conflict-free placement, as shown in FIGS. 16A-16B.

Once the QR® codes are detected, each set of ADNs that are spatially contiguous form a CD and get to know each other's IPs to talk to each other via the network communication. They use this dialogue to find the ADN with the largest number of neighbors using the largest number of overlapping pixels as a tie breaker to decide on the reference ADN for each CD. Once the reference is decided, the cascading homography method takes over to label them, find their configuration and achieve seamless registration. Although the entire system can have n ADNs, the labels of ADNs in each CD will be no more than m, which is the number of projectors present in that specific CD. Since multiple CDs can exist, ADNs in different CDs can have the same label. The application querying the system finds out the number of CDs in the display.

Interaction for 3D Model Manipulation

Once the CDs are created and the personal displays are connected to a CD, gesture based interactions are used to navigate or edit the models in collaboration or alone. A laser based interactions may be used since they can be ergonomically most appropriate when dealing with large displays and people are quite used to using distal interaction devices like remotes and laser pointers today. The gesture data is composited of a list of 2D points that represents the position of the laser in the CD. Further, unlike hand-gesture recognition, which is susceptible to environmental lighting conditions (e.g. when content is projected onto the hand) laser is more robust and resilient to environmental conditions. Since the light intensity of a laser pointer is very high, it is very easy to threshold the visual input to accurately find the laser point. This can be done regardless of the content that is being projected. Furthermore, different laser colors can be used to denote multiple users in a collaborative environment. It may be possible for a gesture (panning by movement of laser) to span multiple ADNs in a CD where each ADN sees only a portion of the gesture. Alternatively, it may be possible for an ADN not to see any gesture at all, but be expected to react to the gesture (when the gesture is confined to a part of the CD not seen by an ADN). To assure appropriate hand-off of gestures and handling of race conditions, a distributed interaction paradigm is used. Each ADN runs a distributed SPMD (single program multiple data) gesture management and reaction management technique. With each gesture, the CD reacts using backend processes. The gesture information is also provided through the API. The user can use the gesture information to define new gestures specifically for their application.

Back End Processes

Data Management

A major bottleneck in modeling of very large models that cannot instantly fit into the RAM of a single machine is the data management without creating duplicates so that data consistency can be maintained easily. A sort-first rendering architecture is used to propose an interleaved data partitioning along with associated methodologies that can achieve a load balanced (both in terms of storage and rendering) data management using a PC cluster in the back end. The data management technique is used to achieve modeling of massive 3D data. This method assumes a static number of machines in the PC cluster and proposes a data partitioning preprocessing which is then adaptively repartitioned in real-time with any edits that add, delete or move data during runtime.

Since the conglomerate display (CD) on which the data is shown can have multiple configuration during a work session, it is difficult to reprocess the data for partitioning on a different subset of machines every time a reconfiguration happens. To alleviate this problem, the data backbone of the system is considered to be comprising of all the PCs present in the shared workspace. This allows for the display reconfiguration on a subset of machines only in the front end for the purpose of user interface and shared processing the rendering load, while all the machines in the workspace share the load of data management in the back end. This assures that data requests coming from any CD is guaranteed to be available in the system. Having a larger number of PCs in the back end also assures better performance in terms of data access and management. To accommodate any reconfiguration, the calibration data is used to identify who are the neighbors of each ADN with respect to their current position to create a lookup table that compensates for the change of neighborhood information that was calculated during the preprocessing phase.

Sort-last rendering architecture can also be supported with the present system. In a sort-last architecture, the cluster of compute units can load balance the rendering of the scene and transfer fragment data to the appropriate ADN. An additional compute unit is needed to coordinate the load balancing process and partitioning the scene that each compute unit is responsible for. Furthermore, there is a trade-off in terms of data management overhead, since each compute unit needs to have its own copy of the data-set, and any data modification requires that all copies of the data-set to be updated.

Portable Desktop Interface

One of the critical capabilities in the nomadic displays paradigm is the portable desktop interface that allows for a desktop to connect to a CD so the user can run any application from his desktop on the wall-top shared display. This interface may be used for 2D data and also for multi-displays made up of LCD panels instead of projectors.

Desktop Connection to a CD

In order to achieve this, each ADN has a dedicated channel to accept external image data. A simple protocol is used to send image data to the ADNs. In order to communicate with the ADNs, a device needs to be on the communication network. Using the configuration information, a client can identify each ADN and send the corrected image data. For receiving image data, the system can operate in two modes: client-centric mode and ADN-centric mode. In client-centric mode, the client uses the configuration information to partition and correct the image for each ADN and send each ADN their respective image data according to their display space. Since the separation and image correction can be computationally expensive for a device, when the number of ADNs is large, the system can also accept full image data, this is called ADN-centric mode. In this mode, the client sends the entire image data to all the ADNs in the CD. Each ADN partitions the image data and transforms the image to the display space. Since the complete image data is sent to all the ADNs in the CD, each ADN receives data that it doesn't need. Therefore, the network is saturated with duplicated data, which severely limits the number of video streams. Thus, the system may preferably be operated in the client-centric mode unless a large data bandwidth is available.

Multiple Desktops on a CD

To stream multiple desktops, each desktop needs to have a client. The ADN separates the number of sources based on the originating host address. Each source is allocated an image data buffer to store the incoming data and make it available to the renderer. Using the configuration information, each client identifies where it wants its content to be displayed on the CD. The client captures its desktop and sends the partitioned and corrected image data to the appropriate ADN in the CD. The same operation is used when a user wants to change his desktop position or size on the CD. As previously described, the system can operate in two modes in this case too.

Interacting with Desktop Data Via Laser Pointer

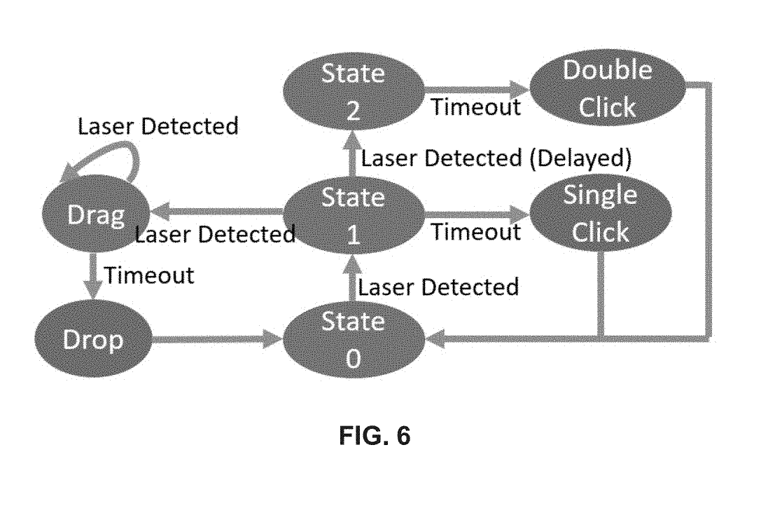

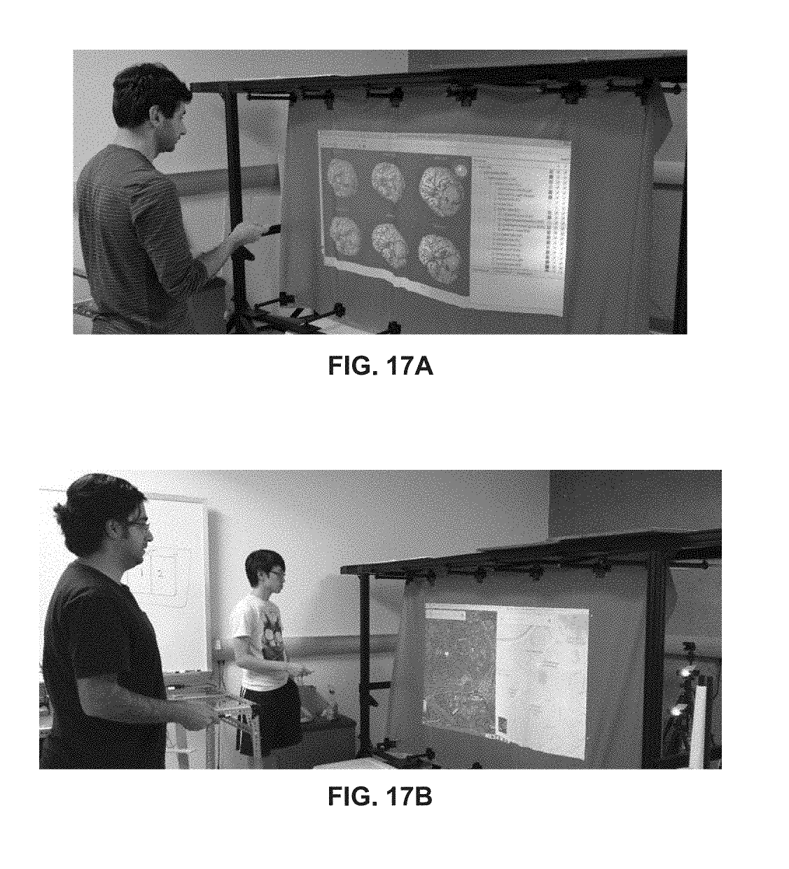

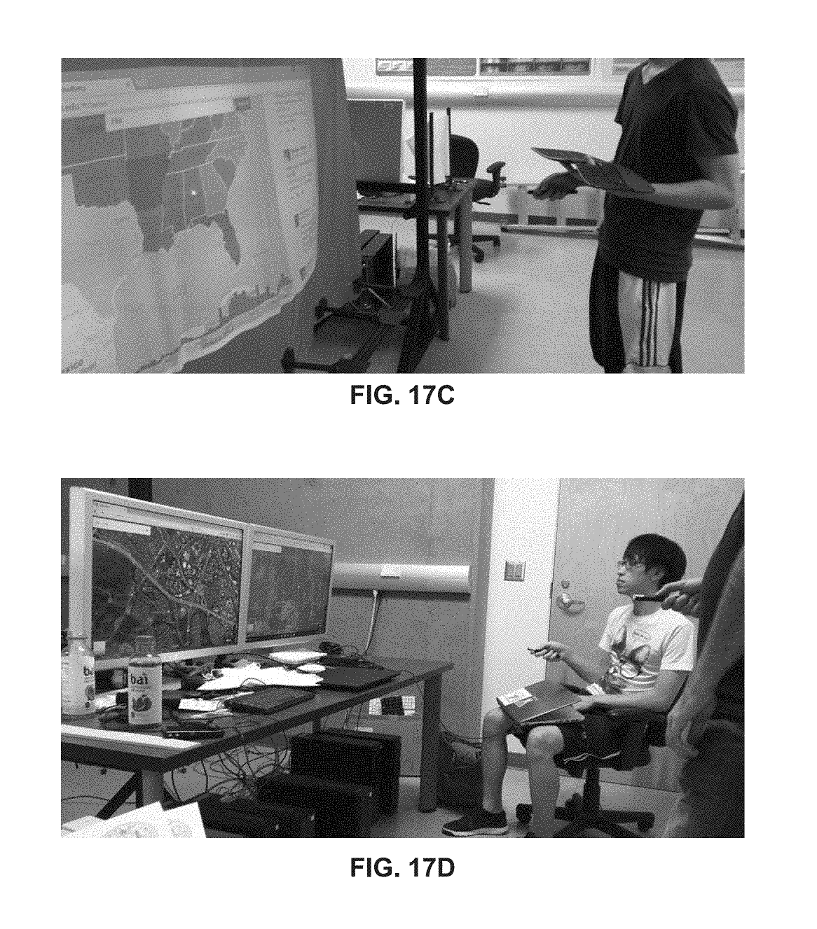

In a non-limiting example, a distributed gesture and reaction management system may be used to allow laser-based interaction with each desktop. This allows the camera to consider the laser pointer to be interacting with a single display even though the desktop is occupying different pixels in multiple display nodes. FIG. 6 depicts a flowchart that finds mouse events based on a series of laser-pointer coordinates. This OS level mouse events are sent to each streaming machine concurrently. The system finds continuous laser pointer movement in a neighborhood as a drag and drop action. A discontinuous laser pointer action followed by timeout is detected as a single mouse click. Two distinct laser pointer detection in the close proximity of each other followed by a timeout is detected as a double click. Similarly, a triple click is detected and converted to the mouse wheel following which the laser pointer acts as a mouse wheel. Moving the laser pointer up and down is then used to provide the scroll up and down features respectively. Some examples of the laser based interaction are shown in FIGS. 17A-17D.

Interacting with Data Via Desktop Interaction

As another non-limiting example, a new modality for interacting with data may be achieved by rearranging the ADNs. One challenge when sharing resources is version mismatch, where multiple users work on outdated version of a resource and hence conflicts arises when the resources are committed back into the repository. Since this system enables users to collaborate and work in a shared environment, a version control mechanism using the display is proposed. The mechanism supports two operations: checkout and commit. When a resource is checked out, it is locked and no one else will be able to checkout that resource. Once a resource is committed, the resource is unlocked and is available for checking out.

When the initial data distribution is done, a meta file is created which is then shared with every ADN. This meta file contains the information of each data block and in which ADN each data block is stored and where. This is the file that is updated during runtime redistribution. To implement the data checkout, the specified ADN(s) forming the personal CD takes over the object, as indicated by the user, and creates a local copy of the object rendering only that object. When a user selects a portion of the model, the system groups all the data blocks into an object in the model. Each ADN in the CD marks the objects data block as locked in the meta file which is then broadcast to other ADNs as well. The personal CD switches context to an independent CD, and no longer associates itself original shared CD. This effectively removes the personal CD from being neighbors with the other ADNs in the shared CD and therefore, the adjacency cache of this CD is no longer available. Once this dissociation is achieved, the user needs to reposition this personal CD such that it does not overlap with the shared CD—essentially the personal CD segments out from the shared CD. The user can modify the local copy of the object in the personal CD and it will not affect the original data due to the lock on the metafile. Data redistribution due to the edits will be limited to the personal CD. When the user wants to commit the changes back into the original data set, the user repositions the personal CD to overlap with the shared CD. Through the visual input, the shared CD can detect an intention to join from another CD. The system recalibrates itself and the personal CD containing the modified data will unlock the data in the meta file which is then broadcast to all the ADNs. Once this is achieved, the next redistribution triggered by the edit will use all the ADNs to achieve the redistribution and hence a better load balancing of rendering and data.

Conclusion

The preceding example details an end-to-end system to suit an application which can have profuse use in the future era of 3D data design, manipulation and display. The system provides a framework of multiple steerable projector camera units to create a paradigm of nomadic displays for collaborative manipulation of massive 3D geometry. Since the invention presents a paradigm, it can be extended to be a much more sophisticated interface for handling a large gamut of collaborative applications in an open shared workspace.

Two kinds of user interactions have been demonstrated: hand gestures and laser based interactions. Note the modality of these interactions can be easily changed by changing the interaction detection module. The system can easily plug in any kind of input modality. The system may be used on a planar surface for creating the nomadic display. In addition, the system may also be used such that the imagery can be registered at corners or multi-planar surfaces—the most common situation faced in open work spaces. The system can also adapt current distributed methodologies for creating multi-projector displays on arbitrary surfaces to adapt to more complex surfaces. The back-end processes are responsible for handling application-specific tasks like synchronization and rendering. Alternatively, instead of a 3D model, the same processes can be used to handle 2D data creating common 2D communal displays.

As used herein, computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. Examples of input devices include a keyboard, a cursor control devices (e.g., a mouse), a microphone, a scanner, and so forth. Examples of output devices include a display device (e.g., a monitor or projector), speakers, a printer, a network card, and so forth. Display devices may include display devices that provide visual information, this information typically may be logically and/or physically organized as an array of pixels. An interface controller may also be included that may comprise any of a variety of known or future software programs for providing input and output interfaces. For example, interfaces may include what are generally referred to as “Graphical User Interfaces” (often referred to as GUI's) that provides one or more graphical representations to a user. Interfaces are typically enabled to accept user inputs using means of selection or input known to those of ordinary skill in the related art. The interface may also be a touch screen device. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft Windows Powershell that employs object-oriented type programming architectures such as the Microsoft .NET framework. Non-liming examples of computers include laptops, desktops, and mobile devices such as tablets, smartphones, and smartwatches.

Those of ordinary skill in the related art will appreciate that interfaces may include one or more GUI's, CLI's or a combination thereof. A processor may include a commercially available processor such as a Celeron, Core, or Pentium processor made by Intel Corporation, a SPARC processor made by Sun Microsystems, an Athlon, Sempron, Phenom, or Opteron processor made by AMD Corporation, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation; the Mac OS X operating system from Apple Computer Corp.; a Unix or Linux-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

System memory may include any of a variety of known or future memory storage devices that can be used to store the desired information and that can be accessed by a computer. Computer readable storage media may include volatile and non-volatile, removable and non-removable media implemented in any method or technology for storage of information such as computer readable instructions, data structures, program modules, or other data. Examples include any commonly available random access memory (RAM), read-only memory (ROM), electronically erasable programmable read-only memory (EEPROM), digital versatile disks (DVD), magnetic medium, such as a resident hard disk or tape, an optical medium such as a read and write compact disc, cloud storage, or other memory storage device. Memory storage devices may include any of a variety of known or future devices, including a compact disk drive, a tape drive, a removable hard disk drive, USB or flash drive, or a diskette drive. Such types of memory storage devices typically read from, and/or write to, a program storage medium such as, respectively, a compact disk, magnetic tape, removable hard disk, USB or flash drive, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with memory storage device. In some embodiments, a computer program product is described comprising a computer usable medium having control logic (computer software program, including program code) stored therein. The control logic, when executed by a processor, causes the processor to perform functions described herein. In other embodiments, some functions are implemented primarily in hardware using, for example, a hardware state machine. Implementation of the hardware state machine so as to perform the functions described herein will be apparent to those skilled in the relevant arts. Input-output controllers could include any of a variety of known devices for accepting and processing information from a user, whether a human or a machine, whether local or remote. Such devices include, for example, modem cards, wireless cards, network interface cards, sound cards, or other types of controllers for any of a variety of known input devices. Output controllers could include controllers for any of a variety of known display devices for presenting information to a user, whether a human or a machine, whether local or remote. In the presently described embodiment, the functional elements of a computer communicate with each other via a system bus. Some embodiments of a computer may communicate with some functional elements using network or other types of remote communications. As will be evident to those skilled in the relevant art, an instrument control and/or a data processing application, if implemented in software, may be loaded into and executed from system memory and/or a memory storage device. All or portions of the instrument control and/or data processing applications may also reside in a read-only memory or similar device of the memory storage device, such devices not requiring that the instrument control and/or data processing applications first be loaded through input-output controllers. It will be understood by those skilled in the relevant art that the instrument control and/or data processing applications, or portions of it, may be loaded by a processor, in a known manner into system memory, or cache memory, or both, as advantageous for execution. Also, a computer may include one or more library files, experiment data files, and an internet client stored in system memory. For example, experiment data could include data related to one or more experiments or assays, such as detected signal values, or other values associated with one or more sequencing by synthesis (SBS) experiments or processes. Additionally, an internet client may include an application enabled to access a remote service on another computer using a network and may for instance comprise what are generally referred to as “Web Browsers”. In the present example, some commonly employed web browsers include Microsoft Internet Explorer available from Microsoft Corporation, Mozilla Firefox from the Mozilla Corporation, Safari from Apple Computer Corp., Google Chrome from the Google Corporation, or other type of web browser currently known in the art or to be developed in the future. Also, in the same or other embodiments an Internet client may include, or could be an element of, specialized software applications enabled to access remote information via a network such as a data processing application for biological applications.

A network may include one or more of the many various types of networks well known to those of ordinary skill in the art. For example, a network may include a local or wide area network that may employ what is commonly referred to as a TCP/IP protocol suite to communicate. A network may include a network comprising a worldwide system of interconnected computer networks that is commonly referred to as the Internet, or could also include various intranet architectures. Those of ordinary skill in the related arts will also appreciate that some users in networked environments may prefer to employ what are generally referred to as “firewalls” (also sometimes referred to as Packet Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

As used herein, the term “about” refers to plus or minus 10% of the referenced number.

The disclosures of the following U.S. Patents are incorporated in their entirety by reference herein: U.S. Pat. Nos. 9,052,584 and 9,064,312.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

1. A user interactive display system comprising:
a. a display surface (101), wherein the display surface is shared by a plurality of display devices;
b. one or more interaction devices (130);
c. the plurality of display devices (102), wherein each display device (104) is operatively connected to one or more computing devices in a network of computing devices (106), wherein the display devices are configured to display one or more images on the display surface, wherein each display device is configured to display a portion of the one or more images;
d. one or more sensors (103), wherein each sensor (105) is operatively connected to one or more of computing devices in the network of computing devices, wherein the sensors are jointly disposed to observe one or more interactions of the one or more interaction devices and jointly disposed to observe the display surface; and
e. the network of computing devices, wherein one or more of the computing devices are configured to execute corresponding instructions, wherein the corresponding instructions are computer-readable instructions comprising:
i. coordinating one or more of the computing devices to jointly display the one or more images using the plurality of display devices;
ii. receiving sensor data from the sensors connected to the computing devices, if any;
iii. processing the sensor data to detect one or more interactions from the one or more interaction devices;
iv. communicating and receiving one or more interactions to and from one or more of the computing devices;
v. determining a reaction to a user interaction; and
vi. executing the reaction to the user interaction;
wherein the plurality of display devices (102) together project the one or more images on the display surface (101), wherein a user (120) controlling one of the interaction devices (130) executes an interaction with the display surface, whereupon one or more sensors (105) detect the interaction, whereupon one or more of the computing devices process the sensor data to determine a user interaction, and whereupon one or more of the computing devices determines and executes a reaction to the user intent.

2. The system of claim 1, wherein one or more of the computing devices are operatively coupled to only the sensors, or only the plurality of display devices, or both the sensors and display devices, or none of the sensors or display devices.

3. A user interactive display system comprising:
a. a display surface (101), wherein the display surface is shared by a plurality of display devices;
b. one or more interaction devices (130);
c. the plurality of display devices (102), wherein each display device (104) is operatively connected to a computing device in a network of computing devices (106), wherein the display devices are configured to display one or more images on the display surface, wherein each display device is configured to display a portion of the one or more images;
d. one or more sensors (103), wherein each sensor (105) is operatively connected to a computing device in a network of computing devices, capable of observing an interaction of one or more of the interaction devices, wherein the sensors are jointly disposed to observe the display surface; and
e. the network of computing devices, wherein one or more of the computing devices are configured to execute corresponding instructions, wherein the corresponding instructions are computer-readable instructions comprising:
i. coordinating with the other computing devices to jointly display the one or more images using the plurality of display devices;
ii. receiving sensor data from the sensors connected to the computing devices, if any;
iii. processing the sensor data to detect an interaction of the interaction device;
iv. communicating interactions to other computing devices;
v. receiving interactions from other computing devices;
vi. determining a reaction to a user interaction; and
vii. executing the reaction to the user interaction;
wherein the plurality of display devices (102) together project the one or more images on the display surface (101), wherein a user (120) controlling one of the interaction devices (130) executes an interaction with the display surface, whereupon one or more sensors (105) detect the interaction, whereupon one or more of the computing devices process the sensor data to determine a user interaction, and whereupon one or more of the computing devices determines and executes a reaction to the user intent.

4. A user interactive display system comprising:
a. a display surface (101), wherein the display surface is shared by a plurality of display devices;
b. one or more interaction devices (130);
c. the plurality of display devices (102), wherein each display device (104) is operatively connected to a computing device in a network of computing devices (106), wherein the display devices are configured to display an image on the display surface, wherein each display device has a display field, wherein the display field comprises the shape and position of the portion of the display surface that the display device is configured to display upon, wherein each display device is configured to display a portion of the image in their display field;
d. one or more sensors (103), wherein each sensor (105) is operatively connected to a computing device in the network of computing devices and capable of observing one or more interactions of the one or more interaction devices, wherein each sensor has a field of view, wherein the interaction must be within the field of view of the sensor to be observed, wherein the fields of view of the one or more sensors are jointly disposed to observe the display surface;
e. a communications network (107), capable of sending communications between the plurality of display devices, the one or more sensors, and the network of computing devices; and
f. the network of computing devices (106), wherein one or more of the computing devices are configured to execute corresponding instructions, wherein the corresponding instructions are computer-readable instructions comprising:
i. detecting the plurality of display devices connected to one or more of the computing devices;
ii. for each display device connected to one or more of the computing devices:
A. detecting the neighboring display devices;
B. communicating with other computing devices to determine which computing devices are connected to the neighboring display devices, wherein the computing devices of the neighboring display devices comprise the neighboring computing devices;
C. determining the display field the display device controls;
D. determining the portion of the image the display device displays based on the display field that the display device controls;
E. registering the portion of the image to the display surface;
F. displaying the image; and
G. communicating with the neighboring computing devices to match the features of the portion of the image to the portions of the image displayed by the neighboring display devices;
iii. detecting one or more sensors connected to the computing device;
iv. determining the portion of the display surface observed by each sensor connected to the computing device;
v. receiving sensor data from the one or more sensors connected to the computing device;
vi. processing the sensor data to detect an interaction of the interaction device;
vii. communicating interactions to one or more of the computing devices;
viii. receiving interactions from one or more of the computing devices;
ix. sending data to one or more of the computing devices;
x. receiving data from one or more of the computing devices;
xi. determining a reaction to a user interaction; and
xii. executing the reaction to the user interaction;
wherein the plurality of display devices (102) together project a display image on the display surface (101), wherein a user (120) controlling one of the interaction devices (130) executes an interaction with the display surface, whereupon one or more of the sensors (105) detects the interaction, whereupon one or more of the computing devices process the sensor data to determine a user intent from the interaction and execute a reaction to the user intent.

5. The system of claim 4, wherein the display surface is curved, flat, or three-dimensional.

6. The system of claim 4, wherein the one or more computing devices communicate and receive one or more interactions from one or more of the other computing devices, wherein the computing devices are operatively coupled to one or more sensors that detect the one or more interactions.

7. The system of claim 4, wherein the reaction comprises altering the image displayed by the network of display devices, wherein the plurality of computing devices execute reactions to modify the portions of the image displayed by the display devices connected to them.

8. The system of claim 4, wherein the reaction comprises transferring data between a first device to a second device, wherein the first device and second device are interaction devices or computing devices.

9. The system of claim 4, wherein the reaction comprises executing a program, wherein the display image is modified to display program data, wherein the program is executed by one or more of the computing devices.

10. The system of claim 4, wherein the network of computing devices comprise a computing cluster, wherein the computing devices share a memory storage and processing time, wherein when a user interacts with an application, the computing cluster distributes the application data and processing across the computing cluster.

11. The system of claim 4, wherein the display device is a projector.

12. The system of claim 11, wherein determining the portion of the image to display comprises determining the overlap region between each display device's display field and the display field of the neighboring display devices, and aligning the content of the image portion with the content of the neighboring image portions in the overlap region.

13. The system of claim 4, wherein the plurality of display devices are video monitors.

14. The system of claim 4, wherein the interaction device is a laser pointer, wherein a plurality of users each are assigned a unique color of laser pointer.

15. The system of claim 4, wherein the interaction device is a mobile computing device, wherein the interaction device of each user is identified by a bar code, wherein the bar code is displayed by or printed on the mobile computing device, wherein the sensor of the display devices views the bar code and the computer of the display device identifies the user by their bar code.

16. The system of claim 4, wherein the interaction device is a mobile computing device, wherein the interaction device is identified by an internet protocol (IP) address, wherein the IP address is transmitted to one or more of the computing devices, wherein the network of computing devices stores the IP addresses of each connected interaction device.

17. The system of claim 4, wherein the interaction device is a mobile computing device, wherein the user logs into the system using user credentials, wherein the interaction device communicates the user credentials to one or more of the computing devices.

18. The system of claim 4, wherein the interaction device is a touch screen, wherein the touch screen is the display surface, wherein the touch screen is the sensor of the display devices, wherein each display device is operatively connected to the portion of the touch screen corresponding to the portion of the image they are displaying.

19. The system of claim 4, wherein the one or more sensors are the one or more interaction devices.

20. The system of claim 4, wherein the one or more sensors are cameras.

21-37. (canceled)
